(19) United States
(12) Patent Application Publication
(10) Pub. No.: US 2025/0069250 A1
(43) Pub. Date: Feb. 27, 2025

(54) PROCESSING SYSTEM, PROCESSING METHOD, AND STORAGE MEDIUM

(71) Applicant: KABUSHIKI KAISHA TOSHIBA, Tokyo (JP)

(72) Inventors: Hirotomo OSHIMA, Yokohama Kanagawa (JP); Takanori YOSHII, Kawasaki Kanagawa (JP); Takehiro KATO, Yokohama Kanagawa (JP); Yasuo NAMIOKA, Nerima Tokyo (JP)

(21) Appl. No.: 18/605,677

(22) Filed: Mar. 14, 2024

(30) Foreign Application Priority Data
Aug. 23, 2023 (JP) 2023-135835

(51) Int. Cl. G06T 7/70

(52) U.S. Cl. CPC G06T 7/70; G06T 2207/20084

(57) ABSTRACT

According to one embodiment, a processing system estimates a pose of a worker based on a first image in which the worker and an article are visible. The processing system estimates at least one selected from a state of the article and a work location of the worker on the article, based on the first image. The processing system generates first graph data including a plurality of nodes and a plurality of edges, based on the pose and the at least one selected from the state and the work location. The processing system inputs the first graph data to a neural network including a graph neural network (GNN). The processing system estimates a task being performed by the worker, by using a result output from the neural network.

### CROSS-REFERENCE TO RELATED APPLICATIONS

This application is based upon and claims the benefit of priority from Japanese Patent Application No. 2023-135835, filed on Aug. 23, 2023; the entire contents of which are incorporated herein by reference.

### FIELD

Embodiments described herein relate generally to a processing system, a processing method, and a storage medium

### BACKGROUND

There is a system that automatically estimates a task being performed. Technology that enables the system to estimate the task with higher accuracy is desirable.

### BRIEF DESCRIPTION OF THE DRAWINGS

FIG. 1 is a schematic view showing a configuration of a processing system according to an embodiment;

FIG. 2A is a schematic view showing a worker and an article, and FIG. 2B is an example of an image acquired by the imaging device;

FIG. 3 is a flowchart showing an example of a processing method according to the embodiment;

FIGS. 4A to 4C illustrate processing by the processing system according to the embodiment;

FIGS. 5A to 5C illustrate processing by the processing system according to the embodiment;

FIGS. 6A to 6C illustrate processing by the processing system according to the embodiment;

FIGS. 7A to 7D illustrate processing by the processing system according to the embodiment;

FIGS. 8A and 8B illustrate processing by the processing system according to the embodiment;

FIGS. 9A to 9C illustrate processing by the processing system according to the embodiment;

FIGS. 10A to 10D illustrate processing by the processing system according to the embodiment;

FIG. 11 is a flowchart showing an estimation method of the article position;

FIG. 12 is a schematic view illustrating the estimation result of the position when tracking processing is performed;

FIG. 13 illustrates processing by the processing system according to the embodiment;

FIGS. 14A to 14D illustrate processing by the processing system according to the embodiment;

FIGS. 15A to 15D illustrate processing by the processing system according to the embodiment;

FIG. 16 is a flowchart showing an overview of the tracking processing;

FIG. 17 is a flowchart showing the update processing of the tracking processing;

FIGS. 18A to 18C are images illustrating processing by the processing system according to the embodiment;

FIGS. 19A to 19C are images illustrating processing by the processing system according to the embodiment;

FIG. 20 is a schematic view illustrating an estimation method of the work location;

FIG. 21 is a flowchart showing the estimation method of the work location;

FIG. 22 is a schematic view illustrating a structure of the first graph data;

FIG. 23 is a schematic view illustrating a structure of the first graph data;

FIG. 24 is a schematic view illustrating a structure of the first graph data;

FIG. 25 is a schematic view illustrating the structure of a neural network;

FIG. 26A illustrates the specific structure of the first graph data, and FIG. 26B illustrates a feature vector;

FIGS. 27A to 27F show specific examples of feature vectors;

FIG. 28 is a schematic view illustrating another structure of a neural network;

FIG. 29 is a schematic view illustrating another structure of the graph data;

FIGS. 30A and 30B are schematic views illustrating another structure of the graph data;

FIG. 31 is a schematic view illustrating another structure of the neural network;

FIG. 32 is a schematic view illustrating another structure of the neural network;

FIG. 33 is a schematic view illustrating the specific structure of the LSTM network;

FIG. 34 is a schematic view illustrating an output result of the processing system according to the embodiment; and

FIG. 35 is a schematic view illustrating a hardware configuration.

### DETAILED DESCRIPTION

According to one embodiment, a processing system estimates a pose of a worker based on a first image in which the worker and an article are visible. The processing system estimates at least one selected from a state of the article and a work location of the worker on the article, based on the first image. The processing system generates first graph data including a plurality of nodes and a plurality of edges, based on the pose and the at least one selected from the state and the work location. The processing system inputs the first graph data to a neural network including a graph neural network (GNN). The processing system estimates a task being performed by the worker, by using a result output from the neural network.

Various embodiments are described below with reference to the accompanying drawings. The drawings are schematic and conceptual; and the relationships between the thickness and width of portions, the proportions of sizes among portions, etc., are not necessarily the same as the actual values. The dimensions and proportions may be illustrated differently among drawings, even for identical portions. In the specification and drawings, components similar to those described previously or illustrated in an antecedent drawing are marked with like reference numerals, and a detailed description is omitted as appropriate.

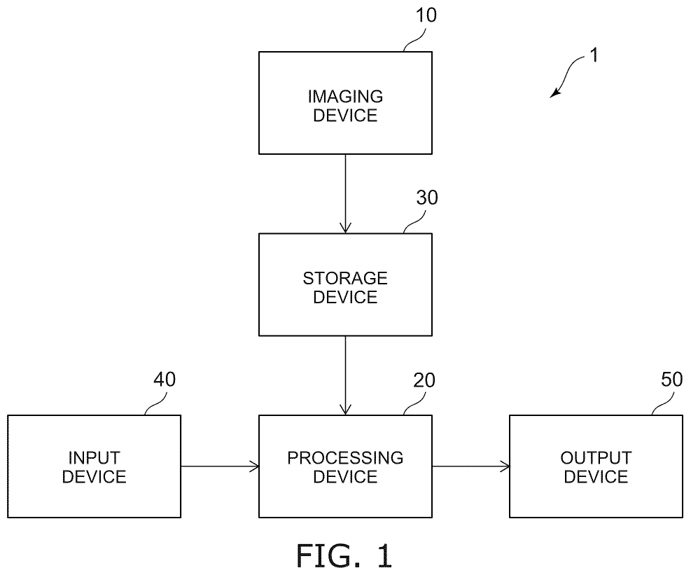

FIG. 1 is a schematic view showing a configuration of a processing system according to an embodiment.

The processing system according to the embodiment is used to estimate a task performed by a worker based on an image. As shown in FIG. 1, the processing system 1 includes an imaging device 10, a processing device 20, a storage device 30, an input device 40, and an output device 50.

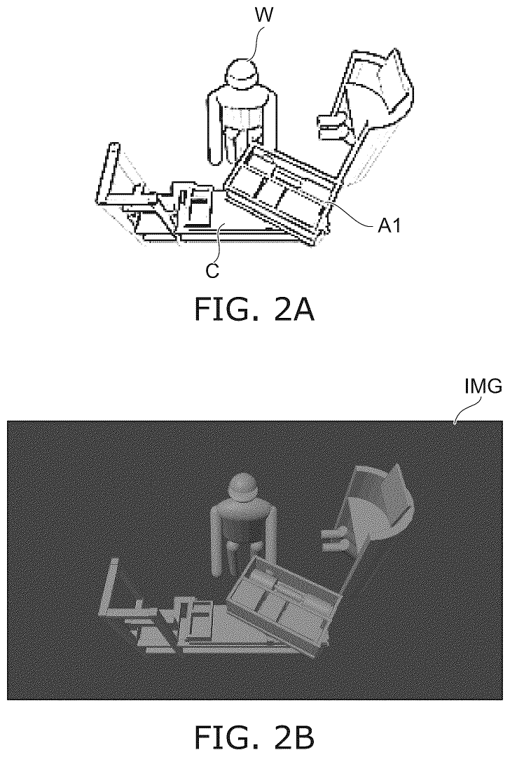

FIG. 2A is a schematic view showing a worker and an article. FIG. 2B is an example of an image acquired by the imaging device.

For example, as shown in FIG. 2A, an article A1 is located on a carrying platform C. A worker W performs a predetermined task on the article A1. The article A1 is a semifinished product, a unit used in a product, etc. The imaging device 10 acquires an image by imaging the worker W and the article A1. FIG. 2B shows an image IMG acquired by the imaging device 10.

Favorably, the imaging device 10 is mounted to a wall, a ceiling, etc., and images the worker W and the article A1 from above. The worker W and the article A1 are easily imaged thereby. The orientation of the imaging by the imaging device 10 may be directly downward or may be tilted with respect to the vertical direction. The imaging device 10 repeatedly acquires images. Or, the imaging device 10 may acquire a video image. In such a case, still images are repeatedly cut out from the video image. The imaging device 10 stores the images or the video image in the storage device 30.

The processing device 20 accesses the storage device 30 and acquires the image acquired by the imaging device 10. The processing device 20 estimates the pose of the worker W, the position of the article A1, the orientation of the article A1, and the state of the article A1 based on the image. The processing device 20 also estimates the work location of the worker W on the article A1 based on the pose, the position, and the orientation. The processing device 20 uses the pose, the state of the article, and the work location on the article to estimate the task being performed by the worker W.

The storage device 30 stores data necessary for the processing by the processing device 20 in addition to images or video images. The input device 40 is used by a user to input data to the processing device 20. The data that is obtained by the processing is output by the processing device 20 to the output device 50 so that the user can recognize the data.

### Processing Method

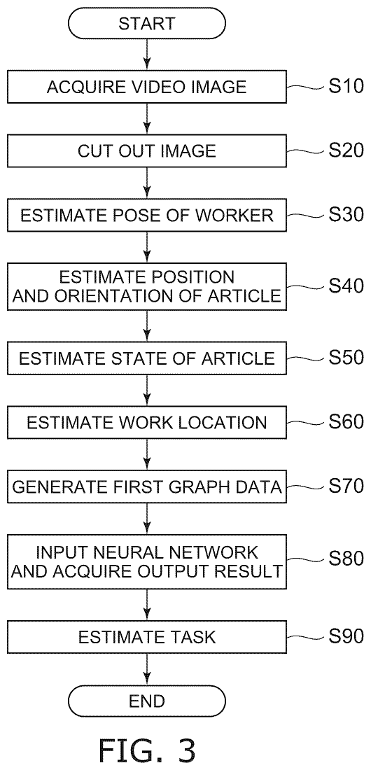

FIG. 3 is a flowchart showing an example of a processing method according to the embodiment.

An overview of the operation of the processing system according to the embodiment will now be described with reference to FIG. 3. The imaging device 10 acquires a video image by imaging a worker and an article (step S10). The processing device 20 cuts out an image from the video image (step S20). The processing device 20 estimates the pose of the worker based on the image (step S30). The processing device 20 estimates the position and orientation of the article based on the image (step S40). The processing device 20 estimates the state of the article based on the image (step S50). The processing device 20 estimates the work location on the article based on the pose of the worker, the position of the article, and the orientation of the article (step S60). The processing device 20 generates first graph data based on the pose of the worker, the state of the article, and the work location on the article (step S70). The processing device 20 inputs the first graph data to a neural network, and acquires an output result from the neural network (step S80). The neural network includes a graph neural network (GNN). The processing device 20 uses the output result from the neural network to estimate the task being performed by the worker (step S90).

The processing performed by the processing device 20 will now be described in detail.

### Pose Estimation

The processing device 20 estimates the pose of the worker W based on an image of the worker W. For example, the processing device 20 inputs the image to a pose estimation model prepared beforehand. The pose estimation model is pretrained to estimate the pose of a person in an image according to the input of the image. The processing device 20 acquires an estimation result of the pose estimation model. For example, the pose estimation model includes a neural network. It is favorable for the pose estimation model to include a convolutional neural network (CNN). OpenPose, DarkPose, CenterNet, etc., can be used as the pose estimation model.

### Position and Orientation Estimation

The processing device 20 extracts two images at different imaging times from among multiple images. The processing device 20 estimates movement information based on the two images. The movement information indicates the movement of an object between one image and the other image. For example, dense optical flow is calculated as the movement information. The method for calculating the dense optical flow is arbitrary; and recurrent all-pairs field transforms (RAFT), total variation (TV)-L1, etc., can be used.

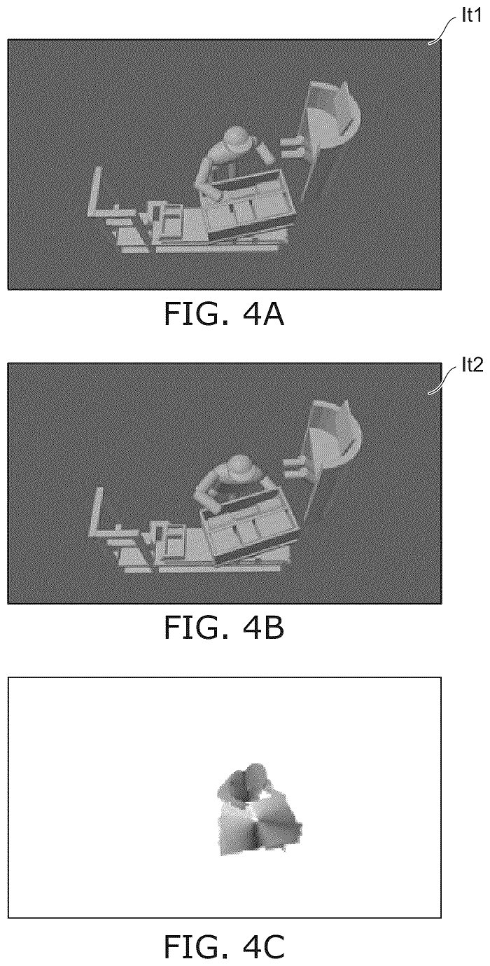

FIGS. 4A to 4C, FIGS. 5A to 5C, FIGS. 6A to 6C, FIGS. 7A to 7D, FIGS. 8A and 8B, FIGS. 9A to 9C, and FIGS. 10A to 10D illustrate processing by the processing system according to the embodiment.

FIG. 4A shows an image It1 imaged at a time t1. FIG. 4B shows an image It2 imaged at a time t2. The time t2 is after the time t1. FIG. 4C shows movement information from the image It1 to the image It2 and is calculated by the processing device 20. In a normal task, mainly, the worker and articles that are related to the task move. When workers, articles, and the like that are related to another task are not visible in the image, the movement information indicates a region in the image in which the worker and the article are visible. Herein, a part of the image including the worker and article indicated by the movement information is called a “partial region”.

The movement information that is used to estimate the position of the article may include the movement of equipment other than the movement of the worker and the movement of the article. The equipment is tools, jigs, etc. However, the shapes of such equipment, the appearance of such equipment in the movement information, the shape of the worker, the shape of the article, and the appearances of the worker and article in the movement information are sufficiently different. Therefore, as described below, by using a “sureness” related to the shape or position of the article, the effects of the movement of tools, the movement of jigs, etc., on the estimation of the position of the article can be sufficiently reduced.

The result of the pose estimation described above shows a region in the image in which the worker is visible. Herein, the region shown by the result of the pose estimation in which the worker is visible is called a “worker region”. The processing device 20 estimates the worker region in the image based on the result of the pose estimation. The processing device 20 uses the worker region as a mask to remove the worker region from the movement information. Only the movement information of the article is obtained thereby. The movement information of the article indicates a region in the image in which the article is visible. Herein, the region indicated by the movement information of the article in which the article is visible is called an “article region”. The article region is estimated based on the movement information of the article.

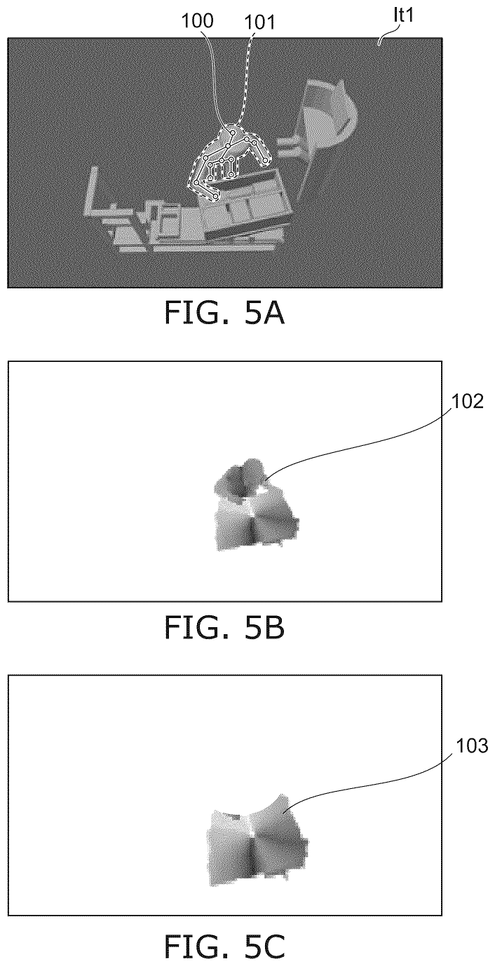

FIG. 5A shows the result of the pose estimation for the image It1 shown in FIG. 4A. The positions of multiple joints 100 are estimated by the pose estimation. As shown in FIG. 5A, a worker region 101 is determined based on the result of the pose estimation. FIG. 5B shows movement information 102 from the time t1 to the time t2. The movement information of the article shown in FIG. 5C is obtained by using the worker region 101 as a mask to exclude a part of FIG. 5B. The movement information of the article indicates an article region 103 in the image It1 in which the article is visible.

The processing device 20 copies the movement information shown in FIG. 5C. The processing device 20 calculates a correlation coefficient with the copied movement information while shifting the position of the movement information upward, downward, leftward, and rightward. A two-dimensional correlation coefficient map is obtained thereby. The processing device 20 estimates the coordinate at which the maximum correlation coefficient in the correlation coefficient map is obtained as the center of the article region. Preprocessing of the copied movement information may be performed when determining the correlation coefficient. For example, the center coordinate of an article translating vertically, an article translating laterally, or a rotating article may be obtained by a vertical inversion, lateral inversion, or vertical and lateral inversion of the copied movement information. The preprocessing of the copied movement information is not limited to such processing.

The processing device 20 estimates contour points of the article by scanning at uniform spacing in N directions from the center of the article region. For example, the point in the correlation coefficient map at which the value initially decreases in the scanning direction is employed as a contour point. N contour points are obtained thereby. As an example, N is set to 36.

The processing device 20 extracts n contour points from the N contour points. The value n is less than the value N. For example, the processing device 20 uses a greedy algorithm to extract the n contour points. In the greedy algorithm, the angle between the contour point of interest and its adjacent contour point is calculated. The processing device 20 calculates the angle between adjacent contour points for each contour point. The processing device 20 extracts the n contour points in order of increasing angle. For example, when the shape of the article when viewed from above is equal to a m-gon or can be approximated by a m-gon, the value m is set as the value n. When the article is circular, the angles between adjacent contour points are substantially equal. In such a case, the value n may be equal to the value N. In other words, the processing of extracting the n contour points may be omitted.

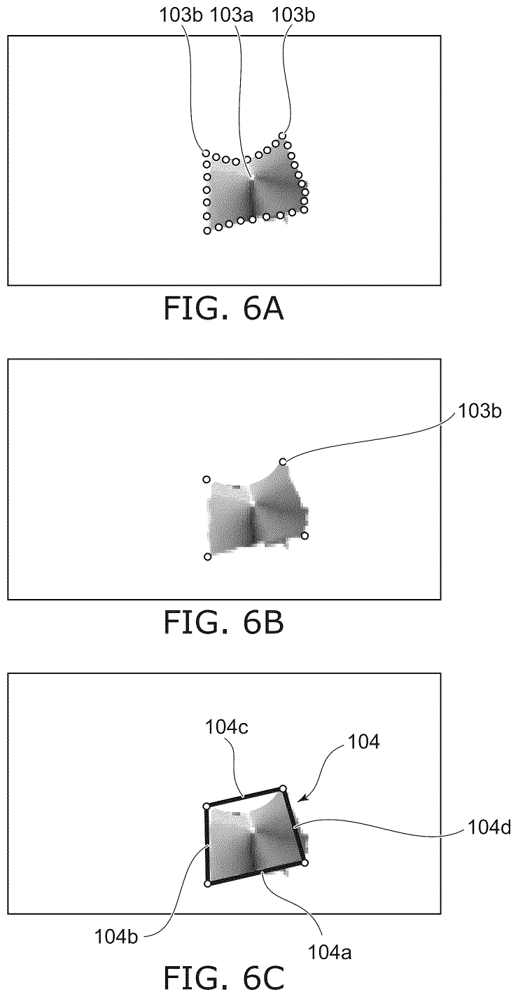

FIG. 6A shows the results of estimating a center 103a and setting N contour points 103b for the article region 103 shown in FIG. 5C. In the example, N is set to 30. Therefore, the thirty contour points 103b are set. In the example shown in FIGS. 5C and 6A, the article A1 is rectangular. The angles between adjacent contour points are small at the corners of the rectangle. As shown in FIG. 6B, the processing device 20 extracts four contour points 103b corresponding to the corners of the rectangle based on the thirty contour points. The contour of the article A1 is estimated by connecting the four contour points 103b. The processing device 20 uses the n contour points to search for the polygon having the highest sureness as the shape of the article. Specifically, the processing device 20 depicts a preset article shape referenced to one of the n sides. The sureness of the position of the depicted shape is calculated based on the estimated contour. The processing device 20 calculates the surenesses by depicting the shape referenced to each side. The processing device 20 employs the position of the shape at which the largest sureness was obtained as the position of the shape of the article A1 in the image.

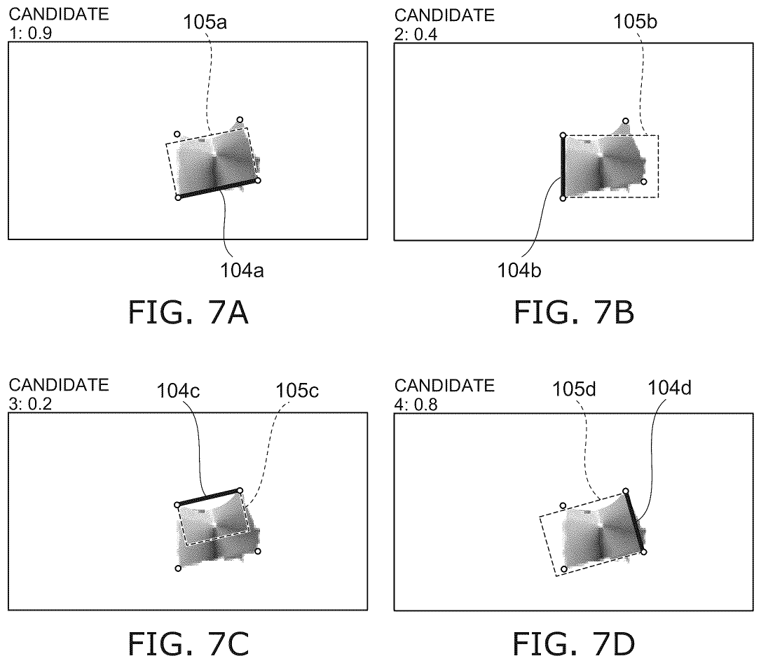

As shown in FIG. 6C, a rectangle 104 that is based on the contour points 103b assumed based on FIG. 6B includes four sides 104a to 104d. FIG. 7A shows the result of depicting a preset rectangle referenced to the side 104a. Similarly, FIGS. 7B to 7D show the results of depicting the preset rectangle referenced to the sides 104b to 104d.

The processing device 20 calculates the likelihoods between the rectangle 104 shown in FIG. 6C and rectangles 105a to 105d shown in FIGS. 7A to 7D as the surenesses of the rectangles 105a to 105d. The average value of the obtained correlation coefficient map inside the rectangle is used as the likelihood. As an example, the likelihoods of the rectangles 105a to 105d shown in FIGS. 7A to 7D are calculated respectively as “0.9”, “0.4”, “0.2”, and “0.8”. The processing device 20 employs the rectangle 105a for which the maximum likelihood is obtained. Or, in the calculation of the likelihoods, images referenced to the rectangles 105a to 105d may be cut out. The processing device 20 may input the images to a model for state classification described below, and may acquire the certainties of the classification results as the likelihoods.

The processing device 20 employs the position of the shape for which the maximum likelihood is obtained as the position of the shape of the article at the time at which one of the two images was imaged. The processing device 20 calculates the coordinate of the position of the article based on the shape that is employed. For example, the processing device 20 uses the center coordinate of the employed shape as the article position. Or, the article position may be calculated from the employed shape according to a preset condition. The processing device 20 outputs the coordinate as the estimation result of the position of the article.

It is favorable for the imaging times of the two images used to estimate the movement information to be separated enough that the movement of the worker or article is apparent. As an example, the imaging device 10 acquires a video image at 25 fps. Therefore, when images that have adjacent imaging times are extracted, the imaging time difference is 1/25 seconds. The movement of the worker or article does not easily appear in 1/25 seconds. The effects of noise and the like in the image increase, and erroneous movement information is easily generated. For example, it is favorable for the imaging time difference between the two images used to estimate the movement information to be greater than 1/20 seconds and less than ½ seconds.

The sampling rate of the video image acquired by the imaging device 10 may be dynamically changed. For example, the sampling rate is increased when the movement of the worker or article is fast. The change of the speed can be determined based on the magnitude of the directly-previous optical flow and the magnitude of the estimated pose coordinate difference of the worker.

The orientation of the article is determined based on the rotation amount of the article with respect to the initial state. For example, the position of the article is estimated based on the initial image, and then the orientation with respect to the article is set. Each time the position of the article is estimated, the processing device 20 calculates the rotation amount of the estimated position with respect to the directly-previous estimation result of the position. For example, template matching is used to calculate the rotation amount. Specifically, the image that is cut out based on the directly-previous estimation result of the position is used as a template. The similarity with the template is calculated while rotating the image cut out based on the estimated position. The angle at which the maximum similarity is obtained corresponds to the rotation amount of the article.

When performing template matching, it is favorable to search for a rotation amount around the directly-previous estimation result. The calculation amount can be reduced thereby. The luminance value difference between corresponding points in the images may be compared to a preset threshold. When the difference is less than the threshold, it is determined that a change has not occurred between the points. A misjudgment in the template matching can be suppressed thereby.

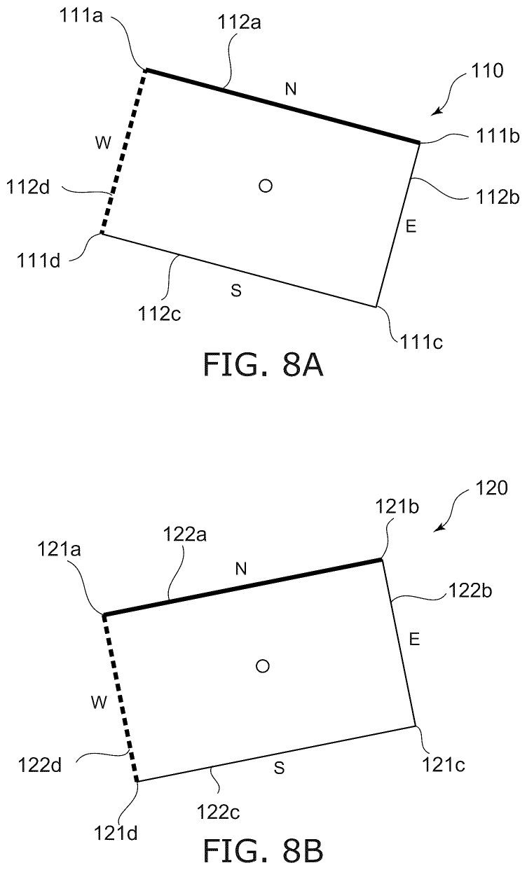

FIG. 8A shows the position of the article estimated at an initial time t11. In the example of FIG. 8A, a rectangle 110 that includes corners 111a to 111d is estimated. “North” (N), “east” (E), “south” (S), and “west” (W) that indicate the orientations are set for sides 112a to 112d between the corners 111a to 111d. “North” and “west” are respectively illustrated by a thick solid line and a thick broken line. FIG. 8B shows the estimation result of the position at a time t12 after the time t11. A rectangle 120 that includes corners 121a to 121d and sides 122a to 122d is estimated. The sides 122a to 122d are estimated to correspond respectively to the sides 112a to 112d based on the history of the rotation amount of the article calculated from the time t11 to the time t12. As a result, “north”, “east”, “south”, and “west” that correspond respectively to the orientations of the sides 112a to 112d are set respectively for the sides 122a to 122d.

The position and orientation of the article are estimated by the processing described above. Here, an example is described in which the article is rectangular. Even when the shape of the article is not rectangular, the position and orientation of the article can be estimated by a similar technique.

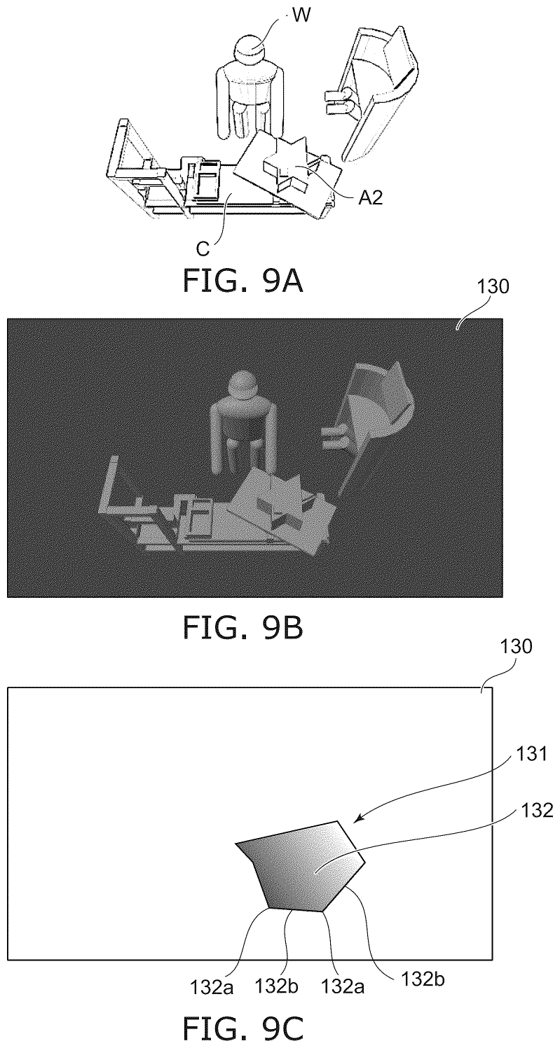

In the example of FIG. 9A, the worker W performs a task on a star-shaped (equilateral hexagram) article A2. FIG. 9B shows an image obtained by imaging the state of FIG. 9A. The processing device 20 uses an image 130 shown in FIG. 9B and another image to estimate an article region 131 shown in FIG. 9C. In the example, the article region 131 is a hexagon 132 that includes six contour points 132a and six sides 132b. As shown in FIG. 9C, there also may be a case where the article region does not correspond to the actual shape of the article due to the shape of the article, the movement of the worker, and the movement of the article.

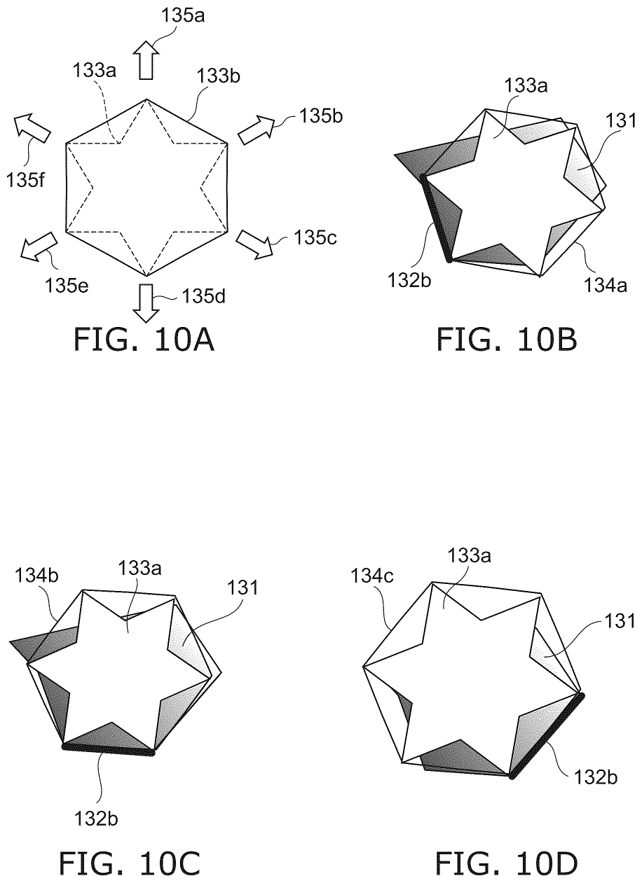

As shown in FIG. 10A, a star shape 133a is preset as the shape of the article A2. Also, a hexagon 133b is preset as a shape corresponding to the star shape 133a. The processing device 20 depicts the preset hexagon 133b referenced to the sides 132b of the hexagon 132. Six hexagons that are respectively based on the six sides 132b are depicted thereby. FIGS. 10B to 10D illustrate some of the six hexagons, namely, hexagons 134a to 134c. The processing device 20 calculates the likelihood of each of the six hexagons. The processing device 20 depicts the star shape 133a referenced to the hexagon for which the maximum likelihood was obtained. The processing device 20 employs the depicted star shape 133a as the shape of the article.

Thereafter, the estimated shape is used to estimate the position and the orientation. The amount of information set to indicate the orientation of the article is arbitrary. In the example of the rectangle shown in FIGS. 8A and 8B, four pieces of information (north, east, south, and west) are used to indicate the orientation of the article. For the star-shaped article A2 shown in FIG. 9A, for example, the orientation of the article may be indicated using six directions 135a to 135f as shown in FIG. 10A.

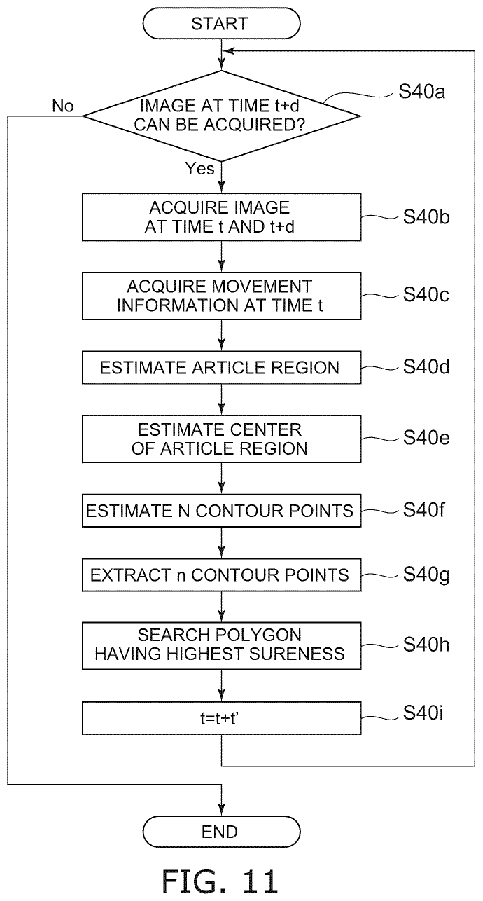

FIG. 11 is a flowchart showing an estimation method of the article position.

The processing device 20 estimates the article position at a time t according to the processing of the flowchart shown in FIG. 11. First, the processing device 20 determines whether or not an image can be acquired at a time t+d (step S40a). In other words, the processing device 20 determines whether or not an image was acquired by the imaging device 10 at the time t+d. When an image can be acquired at the time t+d, the processing device 20 acquires the image at the time t and the image at the time t+d (step S40b). The processing device 20 estimates movement information based on the image at the time t and the image at the time t+d (step S40c). The processing device 20 uses the movement information as the movement information at the time t. The processing device 20 estimates an article region based on the movement information (step S40d). At this time, the result of a pose estimation at the time t is used as a mask.

The processing device 20 estimates the center of the article region (step S40e). The processing device 20 uses the estimated center to estimate N contour points of the article (step S40f). The processing device 20 extracts n contour points from the N contour points (step S40g). The processing device 20 uses the n contour points to search for a polygon having the highest sureness as the shape of the article (step S40h). The processing device 20 employs the coordinate of the center of the polygon obtained by the search as the article position. A value of t′ added to the current time t is set as the time t (step S40i). Subsequently, step S40a is re-performed. As a result, the estimation result of the article position at the time t is repeatedly updated each time the image at the time t+d can be obtained. When the image at the time t+d is determined to be unobtainable in step S40a, the processing device 20 ends the estimation processing of the article position.

### Tracking Processing

The processing device 20 may perform tracking processing in addition to the estimation of the position using the movement information described above. In the tracking processing, the previous estimation result of the position is used to track the position in a newly acquired image.

Specifically, the processing device 20 uses the estimation result of the position in a previous image and cuts out a part of the image in which the article is visible. The processing device 20 stores the cut-out image as a template image. When a new image is acquired, the processing device 20 performs template matching to search for the region in a new image that has the highest similarity. The processing device 20 employs the region obtained by the search as the estimation result of the position in the new image.

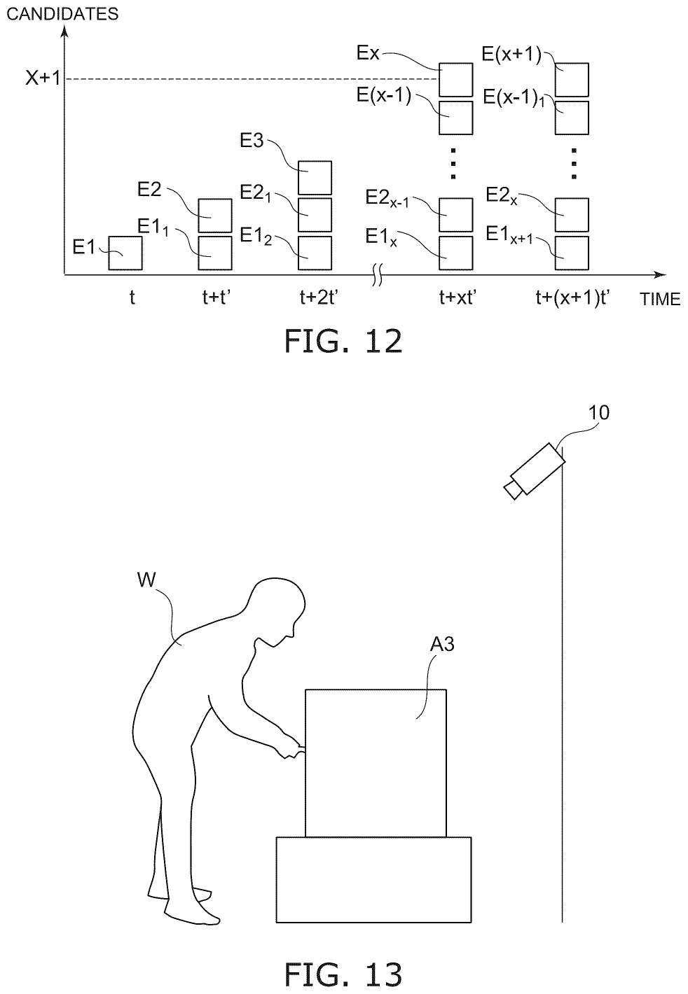

FIG. 12 is a schematic view illustrating the estimation result of the position when tracking processing is performed.

In FIG. 12, the horizontal axis is time. The vertical axis is the number of candidates of the estimated position. For example, an article position E1 is estimated at the time t by using the movement information between the image at the time t and the image at the time t+d. The number of candidates of the article position at the time t is “1”. Similarly, an article position E2 is estimated at the next time t+t′ by using the movement information between the image at the time t+t′ and the image at the time t+t′+d. The processing device 20 estimates an article position E1₁ in the image at the time t+t′+d by using a template image based on the article position E1. As a result, the number of candidates of the estimated article position at the time t+t′ is “2”.

Thereafter, similar processing is repeated each time a new image is acquired. For example, at the time t+xt′, an article position E1ₓ is estimated by repeating the tracking processing based on the article position E1. An article position E2ₓ₋₁ is estimated by repeating the tracking processing based on the article position E2. The processing device 20 employs the article position having the highest sureness at each time as the final article position.

For example, the similarities between a master image prepared beforehand and the images based on the article positions are used as the sureness used to narrow down the final article position. The images may be input to a model for state classification; and the certainties of the classification results may be used as the surenesses.

Or, the sureness may be calculated using a decision model. The decision model includes a deep learning model. The processing device 20 cuts out an image based on the estimation result of the article position and inputs the image to the decision model. The decision model determines whether or not the input image is cut out along the outer edge (the four sides) of the article. The decision model outputs a scalar value of 0 to 1 according to the input of the image. The output approaches 1 as the outer edge of the input image approaches the outer edge of the article. For example, the output is low when a part of the floor surface other than the article is cut out, or only a part of the article is cut out. The processing device 20 cuts out an image for each estimated article position and obtains the outputs for the images. The processing device 20 acquires the outputs as the surenesses for the article positions.

The direction of the imaging by the imaging device 10 may be considered when calculating the sureness. For example, the imaging device 10 images the worker and the article from a direction tilted with respect to the vertical direction. In such a case, the appearance of the article in the image is different between a position proximate to the imaging device 10 and a position distant to the imaging device 10. For example, a side that is proximate to the imaging device 10 appears longer, and a side that is distant to the imaging device 10 appears shorter. Based on this geometrical condition, the length of a reference side for the tilt is prestored in the storage device 30. The processing device 20 reads the length of the reference side stored in the storage device 30 for an angle θq of each article position candidate when tracking. The processing device 20 uses the difference between the length of the reference side and the length of the side of the article position when tracking as the sureness.

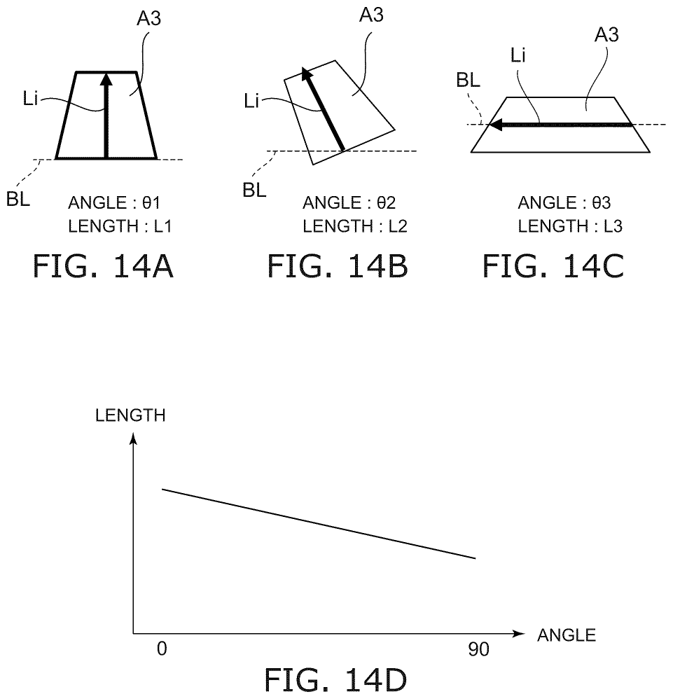

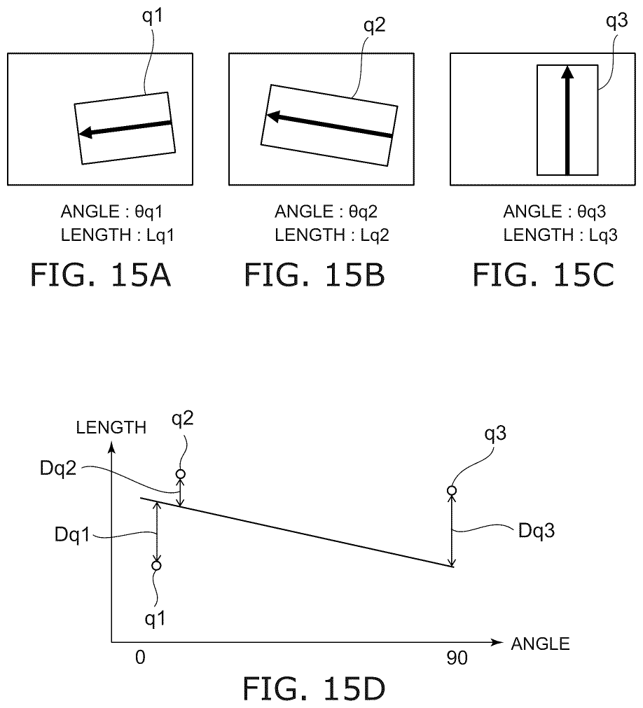

FIG. 13, FIGS. 14A to 14D, and FIGS. 15A to 15D illustrate processing by the processing system according to the embodiment.

For example, as shown in FIG. 13, the worker W performs a task on an article A3. The imaging device 10 images the worker W and the article A3 obliquely from above. The article A3 is rectangular when viewed along the vertical direction.

In such a case, as shown in FIGS. 14A to 14C, the appearance of the article A3 is different according to the relative orientation of the article A3 with respect to the imaging device 10. The processing device 20 utilizes the appearance difference to calculate the sureness of the article position.

Specifically, the processing device 20 uses a preset rule to generate a line segment corresponding to the estimated article position. In the example of FIGS. 14A to 14C, first, the processing device 20 determines the short sides of the article based on the estimated article position. The processing device 20 generates a line segment Li connecting the short sides to each other. The processing device 20 calculates the length of the line segment Li. The processing device 20 also calculates the angle between a reference line BL and the line segment Li. In the example, the reference line BL is parallel to the lateral direction of the image.

As a result of the calculation, angles θ1 to θ3 and lengths L1 to L3 are calculated respectively for the examples of FIGS. 14A to 14C. The angle θ1 is greater than the angle θ2; and the length L1 is less than the length L2. The angle θ2 is greater than the angle θ3; and the length L2 is less than the length L3. In other words, as shown in FIG. 14D, the length of the line segment Li decreases as the angle increases. Such a correspondence between the angle and the length is prestored in the storage device 30.

FIGS. 15A to 15C show rectangles q1 to q3 obtained by the searches. The processing device 20 calculates the length and angle of the line segment connecting the short sides to each other for each of the rectangles q1 to q3. As a result of the calculation, angles θq1 to θq3 and lengths Lq1 to Lq3 are calculated respectively for the examples of FIGS. 15A to 15C.

The processing device 20 refers to the correspondence and acquires the length corresponding to the calculated angle. The processing device 20 calculates the difference between the calculated length and the length corresponding to the angle, and calculates the sureness corresponding to the difference. The calculated sureness decreases as the difference increases.

For example, for the rectangle q1 as shown in FIG. 15D, the processing device 20 calculates a difference Dq1 between the length Lq1 and the length corresponding to the angle θq1. Similarly, the processing device 20 calculates a difference Dq2 and a difference Dq3 for the rectangles q2 and q3. The processing device 20 uses the differences Dq1 to Dq3 to calculate the surenesses of the rectangles q1 to q3. In the example, the difference Dq1 is less than the difference Dq3 and greater than the difference Dq2. Therefore, the sureness of the rectangle q2 is greater than the sureness of the rectangle q3 and less than the sureness of the rectangle q1.

The article position can be estimated with higher accuracy as the number of candidates of the article position increases. On the other hand, if the number of candidates is too high, there is a possibility that the calculation amount necessary for the tracking processing may become excessive, and the processing may be delayed. It is therefore favorable for the number of candidates that are retained to be pre-specified. In the example shown in FIG. 12, “x+1” is set as the specified number. x+1 article positions are estimated at the time t+xt′. x+2 article positions are estimated at a time t+ (x+1) t′. The processing device 20 narrows down the x+2 article positions to x+1 article positions. In the illustrated example, the result of the tracking processing based on the article position Ex is excluded, and the other article positions are extracted. The sureness described above can be used to narrow down the article position. The processing device 20 extracts the x+1 article positions in decreasing order of the sureness.

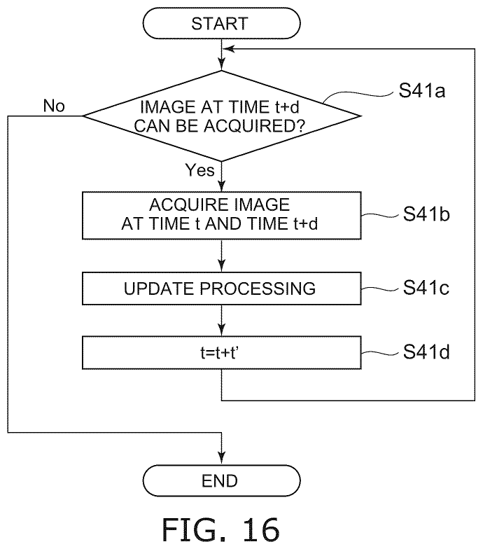

FIG. 16 is a flowchart showing an overview of the tracking processing.

The processing device 20 determines whether or not an image can be acquired at the time t+d (step S41a). When an image can be acquired at the time t+d, the processing device 20 acquires an image at the time t and an image at the time t+d (step S41b). The processing device 20 uses the image at the time t+d to perform position update processing (step S41c). The value of t′ added to the current time t is set as the time t (step S41d). Subsequently, step S41a is re-performed. When an image is determined to be unobtainable at the time t+d in step S41a, the processing device 20 ends the tracking processing.

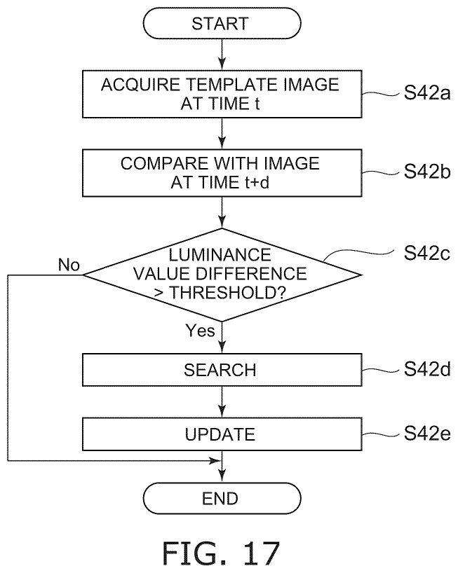

FIG. 17 is a flowchart showing the update processing of the tracking processing.

In the position update processing, the processing device 20 cuts out a part corresponding to the directly previously-estimated position from the image at the time t. The processing device 20 acquires the cut-out image as the template image at the time t (step S42a). The processing device 20 compares the image at the time t+d and the template image at the time t in the tracking candidate region (step S42b). The tracking candidate region is a part of the cut-out image, and is set according to a preset parameter. For example, a region that is 50% of the image wide and 50% of the image long is cut out using the article position at the time t as the center, and is set as the tracking candidate region. The processing device 20 determines whether or not the luminance value difference between the two images is greater than a threshold (step S42c). When the difference is greater than the threshold, the processing device 20 searches for the position and orientation having the highest similarity inside the image at the time t+d while changing the position and orientation of the template image (step S42d). The processing device 20 updates the directly previously-estimated article position to the article position obtained by the search (step S42e). The update processing is skipped when the luminance value difference is not more than the threshold in step S42c. When skipping, the estimation result at a time t−d is inherited. Drift of the template matching is suppressed thereby.

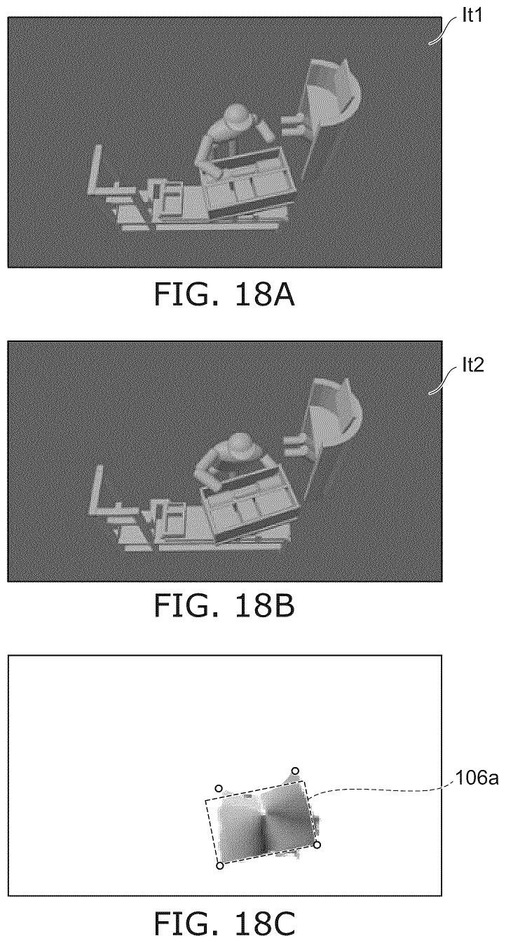

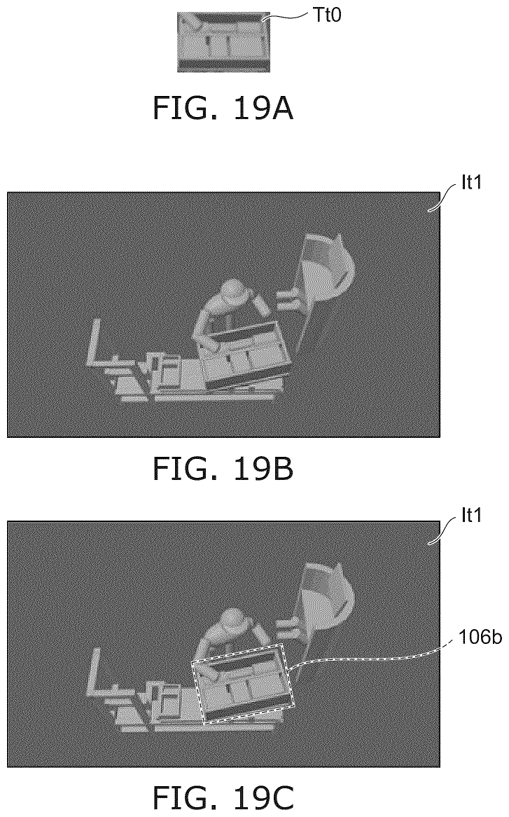

FIGS. 18A to 18C and FIGS. 19A to 19C are images illustrating processing by the processing system according to the embodiment.

FIG. 18A shows the image It1 imaged at the time t1. FIG. 18B shows the image It2 imaged at the time t2. FIG. 18C shows the article position estimated based on the images It1 and It2. A rectangle 106a is employed in the position estimation.

FIG. 19A shows a template image Tt0 at a time t0. The time to is before the time t1. The estimation result of the article position at the time t0 is used to cut out the template image from the image at the time t0. FIG. 19B shows the image It1 imaged at the time t1. FIG. 19C shows a rectangle 106b obtained by tracking processing using the template image Tt0. The article position in the image It1 is illustrated by the rectangle 106b. For example, the final article position is narrowed down from x article positions that include the article position shown in FIG. 18C and the article position shown in FIG. 19C.

### State Estimation

The processing device 20 uses the image to estimate the state of the article in the image. For example, the estimation of the state includes template matching. The processing device 20 compares the image with multiple template images prepared beforehand. The state of the article is associated with each template image. The processing device 20 extracts the template image for which the maximum similarity is obtained. The processing device 20 estimates the state associated with the extracted template image to be the state of the article in the image.

Or, the processing device 20 may input the image to a state estimation model. The state estimation model is pretrained to estimate the state of the article in the image according to the input of the image. For example, the state estimation model includes a neural network. It is favorable for the state estimation model to include a CNN. The processing device 20 acquires the estimation result of the state estimation model.

It is favorable for the processing device 20 to cut out a part from the entire image in which workers, etc., other than the article are visible. The article is visible in the cutout part of the image. The estimation result of the position of the article may be used in the cutout. The cutout increases the ratio of the area of the article visible in the image. The effects of components other than the article on the estimation of the state can be reduced thereby. As a result, the accuracy of the estimation of the state can be increased. When the image is not cut out, it is also possible to directly estimate the state of the article based on the image acquired by the imaging device 10.

### Work Location Estimation

The processing device 20 estimates the work location of the worker on the article based on the estimation result of the pose of the worker, the estimation result of the position of the article, and the estimation result of the orientation of the article. For example, the processing device 20 acquires the position of the left hand and the position of the right hand of the worker based on the estimation result of the pose. The processing device 20 calculates the relative positions and orientations of the left and right hands with respect to the article. The processing device 20 estimates the work locations on the article based on the relative positional relationship.

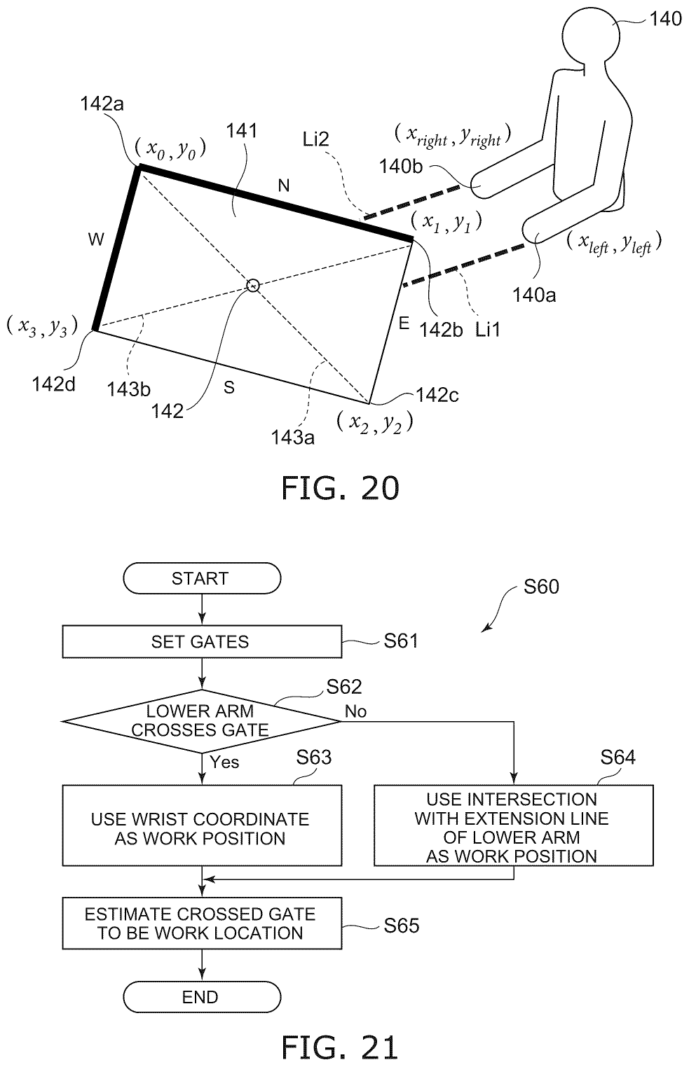

FIG. 20 is a schematic view illustrating an estimation method of the work location.

In the example of FIG. 20, the position (x_{left}, y_{left}) of a left hand 140a and the position (x_{right}, y_{right}) of a right hand 140b of a worker 140 are estimated. A center 142 and the positions (x₀, y₀), (x₁, y₁), (x₂, y₂), and (x₃, y₃) of four corners 142a to 142d are estimated as the position of an article 141. Also, the orientation of the article, i.e., “north”, “east”, “south”, and “west” are estimated. The orientation of the article is subdivided by boundary lines 143a and 143b passing through the center 142. In the example, the diagonal lines of the rectangular article 141 are set as the boundary lines 143a and 143b. The directions and number of the boundary lines are appropriately set according to the shape of the article.

The processing device 20 sets gates for estimating the work locations based on the position and orientation of the article. For example, the processing device 20 sets the gates of north, east, south, and west along the sides of the article 141. As illustrated by a line Li1, the left hand 140a faces the “east” gate. As illustrated by a line Li2, the right hand 140b faces the “north” gate. The line Li1 and the line Li2 are respectively the extension line of the left lower arm and the extension line of the right lower arm. The lower arm is the line segment (the bone) connecting the wrist and the elbow.

Based on the gates and positions of the joints, the processing device 20 estimates that the left hand 140a is positioned at the east side of the article 141. In other words, the work location of the left hand is estimated to be the east side of the article. Also, the processing device 20 estimates that the right hand 140b is positioned at the north side of the article 141. In other words, the work location of the right hand is estimated to be the north side of the article.

The joints that are used to estimate the work locations are arbitrary. For example, the position of the finger, wrist, or elbow may be used to estimate the work location according to the task being performed. The positions of multiple such joints may be used to estimate the work location.

FIG. 21 is a flowchart showing the estimation method of the work location.

The processing device 20 sets the gates in each direction of the article based on the estimated position and orientation of the article (step S61). The processing device 20 determines whether or not the lower arms of the worker cross the gates (step S62). When a lower arm crosses a gate, the processing device 20 sets the position of the left hand and the position of the right hand as the work positions (step S63). When the lower arms do not cross the gates, the processing device 20 sets the intersections between the gates and the extension lines of the lower arms as the work positions (step S64). The processing device 20 estimates the gates crossed by the lower arm or extension line to be the work locations (step S65).

### Task Estimation

The processing device 20 generates the first graph data based on the estimated pose, the estimated state, and the estimated work location. The graph data has a graph-type data structure. The first graph data includes multiple nodes and multiple edges. Nodes that are associated with each other are connected to each other by edges.

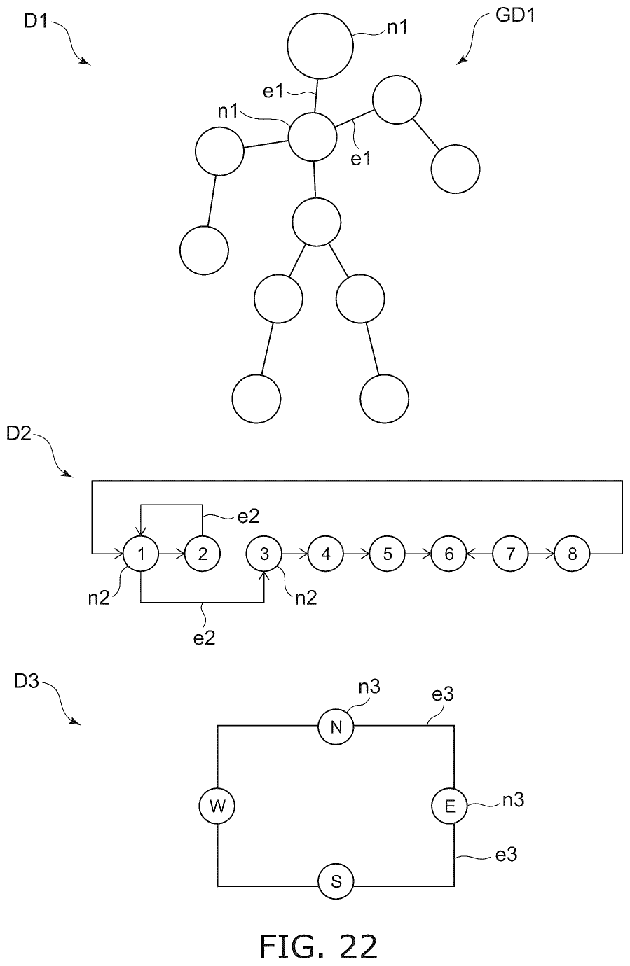

FIGS. 22 to 24 are schematic views illustrating structures of the first graph data.

As shown in FIG. 22, first graph data GD1 includes, for example, first data D1, second data D2, and third data D3. The first data D1, the second data D2, and the third data D3 are separated from each other, and are not connected by edges.

The first data D1 is generated based on the estimation result of the pose. The first data D1 includes multiple first nodes n1 and multiple first edges e1. The multiple first nodes n1 correspond respectively to multiple joints of the worker. The multiple first edges e1 correspond respectively to multiple skeletal parts of the worker. In the example shown in FIG. 22, the positions of the ankles, knees, lower back, chest, wrists, elbows, and head are estimated based on the image; and the multiple first nodes n1 that correspond to these parts are set. The multiple first edges e1 that correspond to skeletal parts connecting these joints are set. Accordingly, edges are not set between joints that are not actually connected. For example, the node of the wrist and the node of the elbow are connected by an edge, but the node of the wrist and the node of the lower back are not connected.

The second data D2 is generated based on the estimation result of the state. The second data D2 includes multiple second nodes n2 and multiple second edges e2. The multiple second nodes n2 correspond respectively to multiple states that the article may be in. The multiple second edges e2 correspond respectively to transitions of the state of the article. In the example shown in FIG. 22, eight second nodes n2 are set because the article can be in eight states. Nine second edges e2 are set to correspond to the possible transitions between these states. For example, a transition from the first state to the second state, a transition from the second state to the first state, a transition from the first state to the third state, etc., may occur. The second edges e2 are set to correspond respectively to these transitions.

The third data D3 is generated based on the estimation result of the work location. The third data D3 includes multiple third nodes n3 and multiple third edges e3. The multiple third nodes n3 correspond respectively to multiple locations of the article which may be worked on. The multiple third edges e3 respectively indicate the associations between the work locations. For example, locations that may be transitioned between during the actual task are connected to each other by edges. In the example shown in FIG. 22, the north node and the east node are connected by an edge. This edge indicates that the work location may transition from the north location to the east location, or from the east location to the north location. Similarly, edges are set respectively between the east node and the south node, between the south node and the west node, and between the west node and the north node. These edges indicate that the work location may transition between these nodes. Edges are not set between the north location and the south location or between the east location and the west location. This configuration indicates that the work location does not transition between the north location and the south location or between the east location and the west location.

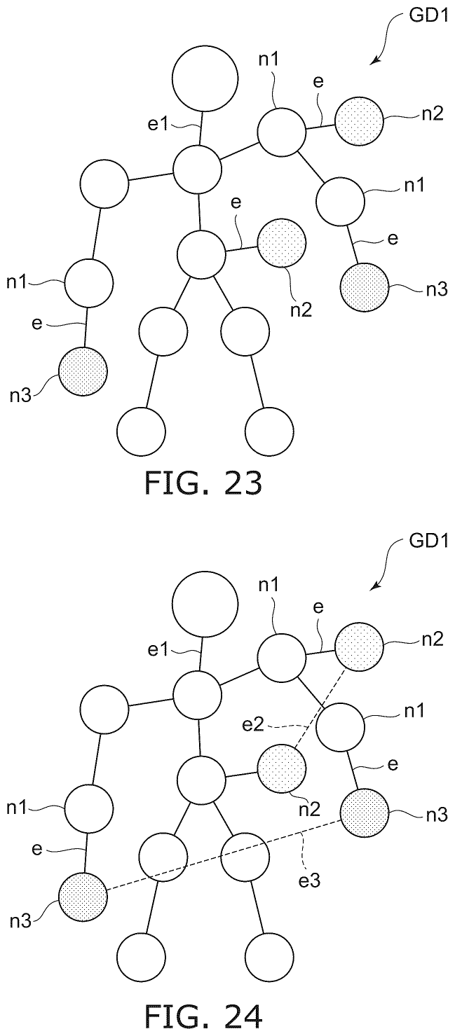

In the first graph data GD1 as shown in FIG. 23, the first nodes n1 and the second nodes n2 may be connected by edges e; and the first nodes n1 and the third nodes n3 may be connected by other edges e. The second nodes n2 are connected with the first nodes n1 that have associations. The third nodes n3 are connected with the first nodes n1 that have associations. As an example, when the association between the position of the lower back of the worker and some state of the article is greater than the association of another combination, the first node n1 of the lower back and the second node n2 of this state of the article are connected by the edge e. When the association between the position of the left elbow of the worker and another state of the article is greater than the association of another combination, the first node n1 of the left elbow and the second node n2 of the other state of the article are connected by the edge e. When some location of the article is worked on mainly by the right hand of the worker, the third node n3 that corresponds to the location is connected with the first node n1 corresponding to the right hand by the edge e. When another location of the article is worked on mainly by the left hand of the worker, the third node n3 that corresponds to the other location is connected with the first node n1 corresponding to the left hand by the edge e.

As shown in FIG. 24, in the first graph data GD1 shown in FIG. 23, the second edge e2 that connects the second nodes n2 to each other also may be set. The third edge e3 that connects the third nodes n3 to each other also may be set. The accuracy of the task estimation can be further increased by setting the second edge e2 or the third edge e3 in addition to setting the edge e that connects the first node n1 and the second node n2 or the edge e that connects the first node n1 and the third node n3.

The first graph data GD1 may include more nodes and edges than those of the illustrated example. For example, nodes that correspond to the neck, shoulders, fingers, etc., and edges that correspond to these nodes also may be set. More states may be set as possible states that the article may be in. The work locations may be finely classified according to the size of the article. The accuracy of the task estimation can be further increased by increasing the nodes. The number of nodes that are set is modifiable as appropriate according to the throughput of the processing device 20.

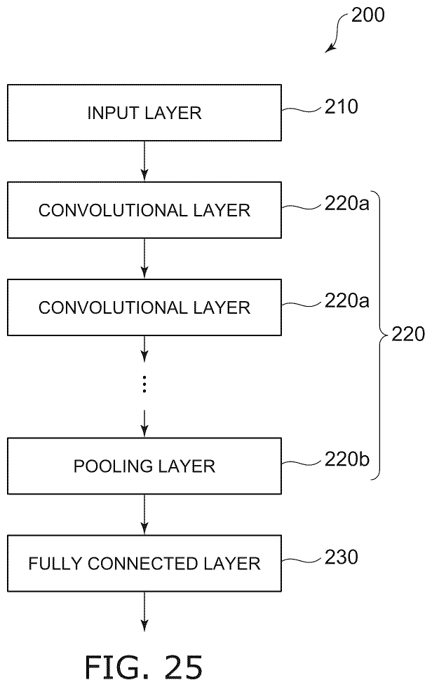

FIG. 25 is a schematic view illustrating the structure of a neural network.

For example, graph data is input to the neural network 200 shown in FIG. 25. The neural network 200 includes an input layer 210, the GNN 220, and a fully connected layer 230. The GNN 220 includes multiple convolutional layers 220a and a pooling layer 220b. The first graph data GD1 of one of FIGS. 22 to 24 is input to the input layer 210. The size of the input layer 210 is set according to the number of nodes of the first graph data GD1 and the number of edges of the first graph data GD1.

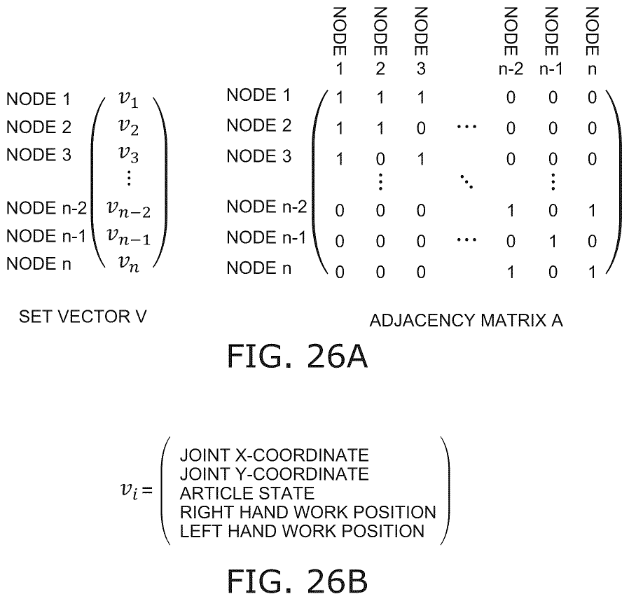

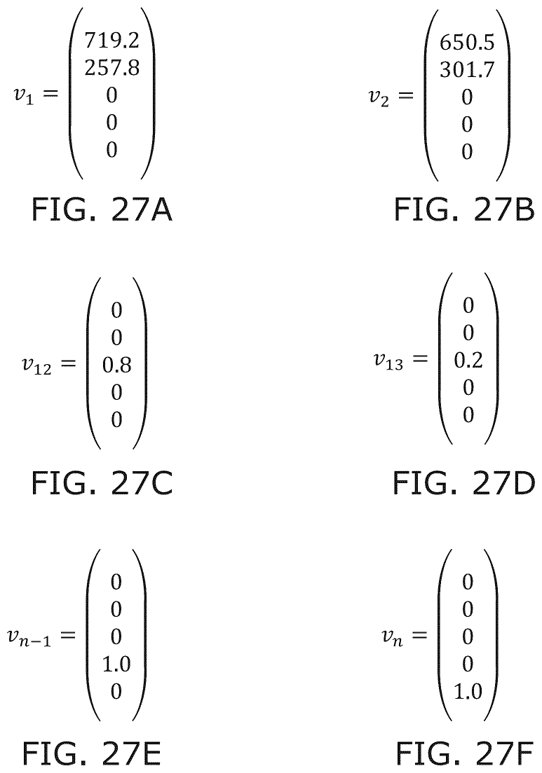

FIG. 26A illustrates the specific structure of the first graph data. FIG. 26B illustrates a feature vector. FIGS. 27A to 27F show specific examples of feature vectors.

Here, an example will be described in which the first graph data GD1 shown in FIG. 23 or FIG. 24 is used. As shown in FIG. 26A, the first graph data includes a set vector V and an adjacency matrix A. The set vector V includes values of the multiple nodes. Each node is represented by a feature vector v. As shown in FIG. 26B, the feature vector v includes the five values of the values representing the X-coordinate of the joint, the Y-coordinate of the joint, and the state of the article, the value representing the work location of the right hand, and the value representing the work location of the left hand.

As an example, FIG. 27A shows a feature vector v₁ corresponding to the node of the left wrist. The feature vector v₁ includes the X-coordinate of the left wrist and the Y-coordinate of the left wrist. The feature vector v₁ does not represent the state of the article or the work locations, and so the values of the state of the article and the work locations are set to “0”. FIG. 27B shows the values of a feature vector v₂ corresponding to the node of the left elbow. The feature vector v₂ includes the X-coordinate of the left elbow and the Y-coordinate of the left elbow. The feature vectors v₁ and v₂ are examples of the first node n1.

FIG. 27C shows a feature vector v₁₂ corresponding to the node of a first article state. In the feature vector v₁₂, a numerical value from 0 to 1 is set as the value representing the state of the article; and the other values are set to “0”. The value that represents the state are set based on the estimation result of the state. The state estimation model outputs the certainty of each state as the estimation result of the state. For example, the certainty that is output is set as the value representing the state of the article. In the feature vector v₁₂, the certainty of “0.8” is set as the value representing the state of the article. FIG. 27D shows a feature vector v₁₃ corresponding to the node of a second article state. In the feature vector v₁₃, the certainty of “0.2” is set as the value representing the state of the article. The feature vectors v₁₂ and v₁₃ are examples of the second node n2.

FIG. 27E shows a feature vector vₙ₋₁ corresponding to the node of the work location of the right hand. The feature vector vₙ₋₁ includes a value representing the work position of the right hand. FIG. 27F shows a feature vector vₙ corresponding to the node of the work location of the left hand. The feature vector vₙ includes a value representing the work position of the left hand. The feature vectors vₙ₋₁ and vₙ are examples of the third node n3.

In the adjacency matrix A shown in FIG. 26A, the associations between the nodes are represented by “0” or “1”. In other words, the presence of each of the first to third edges e1 to e3 is represented by the value of “0” or “1”. “0” indicates that an edge is not present. “1” indicates that an edge is present.

In the GNN 220, each convolutional layer 220a convolves each feature vector v by Formula 1 below. In Formula 1, vᵢ is the initial feature vector of the ith node. vi^{conv(t)} is the updated feature vector of the ith node, and is obtained by the tth convolution. A(i) is the set of the feature vector of the ith node of the set vector V and the feature vector of the nodes defined by the adjacency matrix A as being adjacent to the ith node. Here, “adjacent” means connected by an edge. W(t) is the weight updated t times.

$${v}_{i}^{conv ( t )} = ReLU ( {\sum }_{{v}_{j}^{conv ( t - 1 )} ∈ A ( i )} W ( t ) \cdot {v}_{j}^{conv ( t - 1 )} ) \\ {v}_{j}^{conv ( 0 )} = {v}_{j} \\ ReLU ( x ) = \{ \begin{matrix}x ( x \geq 0 ) \\ 0 ( x < 0 )\end{matrix} \qquad [ Formula 1 ]$$

The output result of the convolutional layers 220a is further reduced by the pooling layer 220b. The output result of the pooling layer 220b is converted into one-dimensional data by the fully connected layer 230. The output result of the fully connected layer 230 corresponds to the estimation result of the task. For example, the fully connected layer 230 outputs the certainty for each class. One class corresponds to one task. The task that corresponds to the class for which the highest certainty is obtained is estimated to be the task being performed.

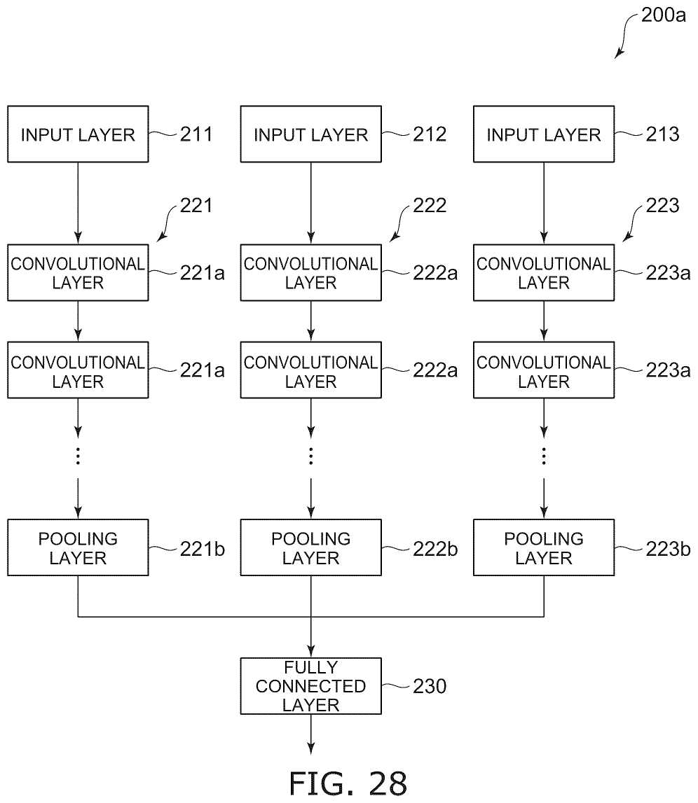

FIG. 28 is a schematic view illustrating another structure of a neural network.

As shown in FIG. 28, the neural network 200a may include input layers 211 to 213, GNNs 221 to 223, and the fully connected layer 230. The first data D1 that is related to the pose is input to the input layer 211. The GNN 221 includes convolutional layers 221a and a pooling layer 221b, and processes the first data D1. The second data D2 that is related to the state of the article is input to an input layer 212. The GNN 222 includes convolutional layers 222a and a pooling layer 222b, and processes the second data D2. The third data D3 that is related to the work location on the article is input to the input layer 213. The GNN 223 includes convolutional layers 223a and a pooling layer 223b, and processes the third data D3. Similarly to the convolutional layer 220a, the convolutional layers 221a to 223a convolve the feature vectors of the nodes. Similarly to the pooling layer 220b, the pooling layers 221b to 223b reduce the convolved feature vectors. The output results of the GNNs 221 to 223 are connected in the fully connected layer 230. The fully connected layer 230 outputs the estimation result of the task.

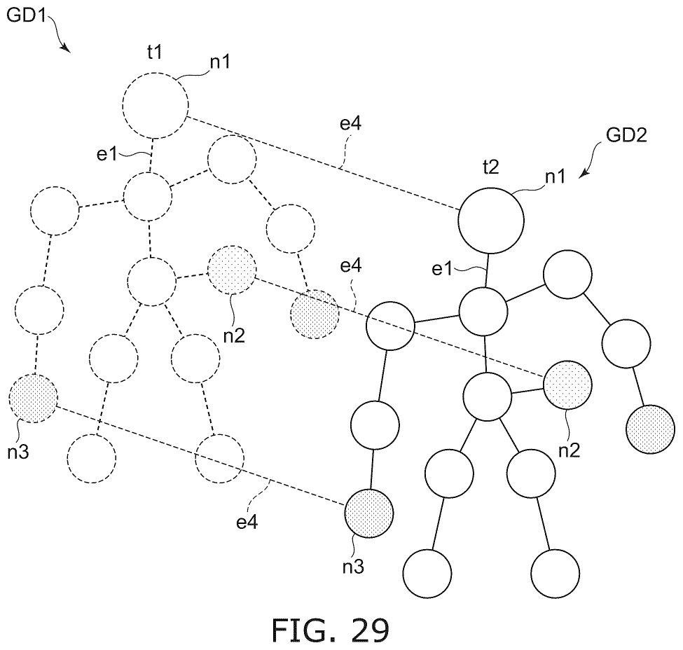

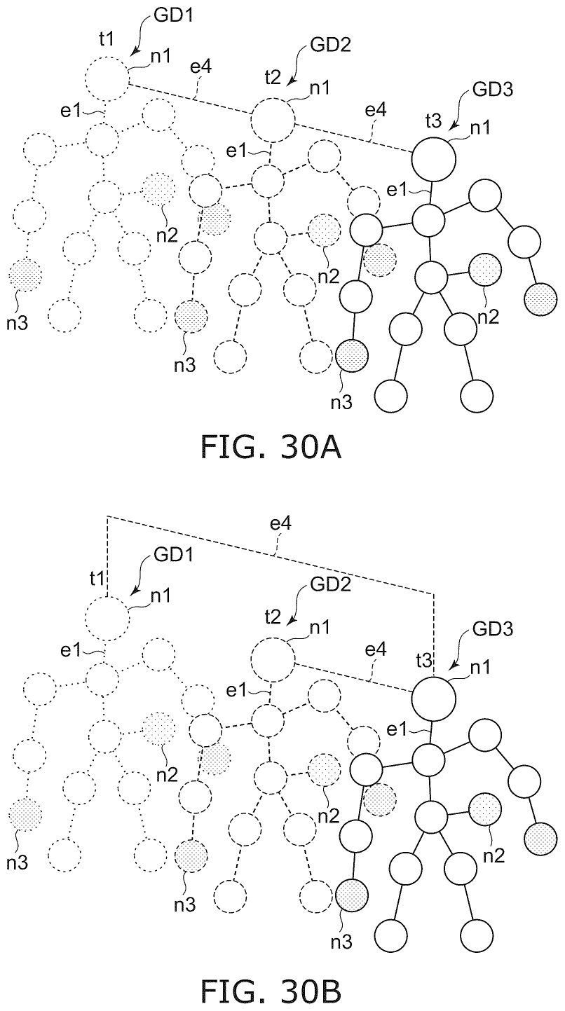

FIGS. 29, 30A, and 30B are schematic views illustrating other structures of the graph data.

Changes of the node values over time may be used in the estimation. For example, as shown in FIG. 29, the first graph data GD1 is generated based on an image (a first image) obtained at the time t1. The first graph data GD1 includes the multiple first nodes n1, the multiple first edges e1, the multiple second nodes n2, and the multiple third nodes n3. Second graph data GD2 is generated based on an image (a second image) obtained at the time t2 after the time t1. Similarly to the first graph data GD1, the second graph data GD2 includes the multiple first nodes n1, the multiple first edges e1, the multiple second nodes n2, and the multiple third nodes n3.

The processing device 20 respectively connects the multiple nodes of the first graph data GD1 and the multiple nodes of the second graph data GD2 with multiple edges e4. FIG. 29 shows only some of the edges e4; the other edges e4 are not illustrated. Specifically, the multiple first nodes n1 of the first graph data GD1 are connected respectively with the multiple first nodes n1 of the second graph data GD2. The multiple second nodes n2 of the first graph data GD1 are connected respectively with the multiple second nodes n2 of the second graph data GD2. The multiple third nodes n3 of the first graph data GD1 are connected respectively with the multiple third nodes n3 of third graph data GD3. The first graph data GD1 and the second graph data GD2 that are connected to each other are input by the processing device 20 to the neural network 200.

In another method, the multiple first nodes included in the first data D1 based on the image at the time t1 and the multiple first nodes included in the first data D1 based on the image at the time t2 are connected to each other. The multiple second nodes included in the second data D2 based on the image at the time t1 and the multiple second nodes included in the second data D2 based on the image at the time t2 are connected to each other. The multiple third nodes included in the third data D3 based on the image at the time t1 and the multiple third nodes included in the third data D3 based on the image at the time t2 are connected to each other. These data are input to the neural network 200a.

As shown in FIG. 30A, images may be acquired at three or more times t1 to t3; and the first to third graph data GD1 to GD3 may be generated based respectively on the three images. For example, the corresponding nodes between the first graph data GD1 and the second graph data GD2 based on the images having mutually-adjacent imaging times are connected to each other by the edges e4. The corresponding nodes between the second graph data GD2 and the third graph data GD3 based on the images having mutually-adjacent imaging times are connected to each other by the edges e4.

One set of graph data may be selected from multiple sets of graph data; and a node of the selected graph data and a node of other graph data may be connected. For example, the third graph data GD3 is selected from the first to third graph data GD1 to GD3. As shown in FIG. 30B, nodes of the first and second graph data GD1 and GD2 may be connected to a node of the third graph data GD3. In such a case, the node of the first graph data GD1 and the node of the second graph data GD2 are not connected by an edge. FIGS. 30A and 30B show only some of the edges e4; the other edges e4 are not illustrated.

By representing the temporal change of each node in a graph structure, the accuracy of the task estimation can be further increased.

In the example shown in FIG. 30A or FIG. 30B, all of temporally consecutive images may not be utilized to generate the graph data. For example, when ten images are acquired between the times t1 to t10, ten sets of graph data may be generated from the ten images; and the nodes of the ten sets of graph data may be connected to each other. A part of the images may be selected from the ten images. In such a case, graph data is generated based on the selected images; and the nodes of the selected images are connected to each other. In any case, the multiple sets of graph data that are connected to each other are input to the neural network 200 or the neural network 200a.

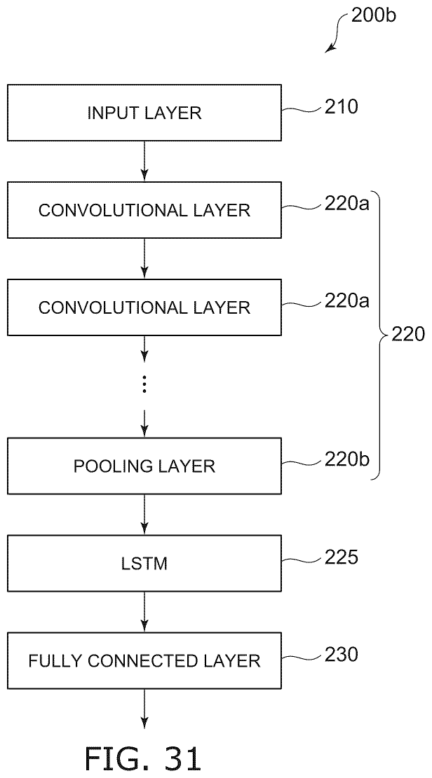

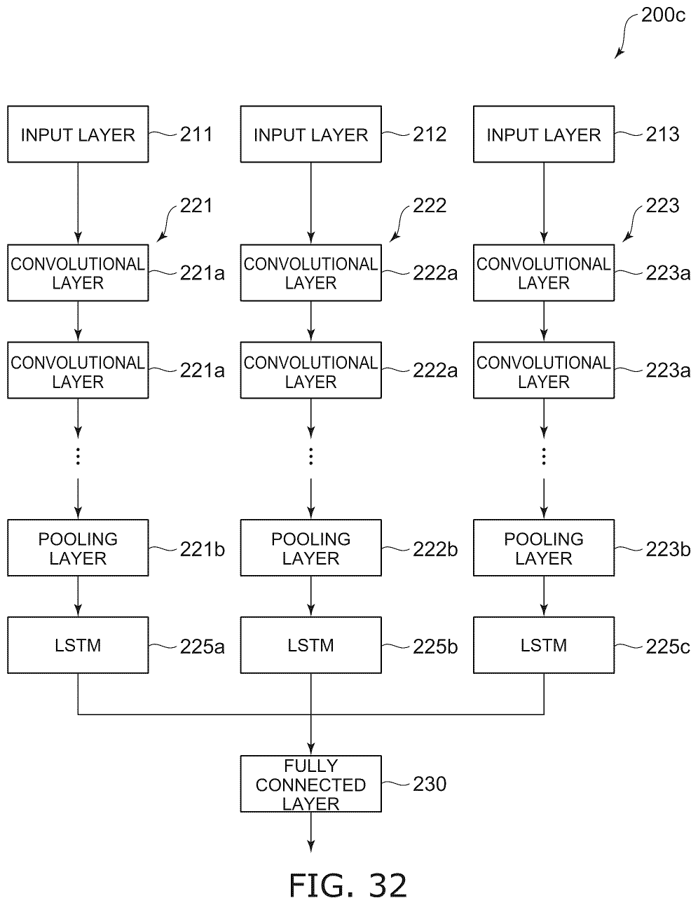

FIGS. 31 and 32 are schematic views illustrating other structures of the neural network.

The neural network may include a long short-term memory (LSTM) network to use the temporal change of the nodes in the estimation. Compared to the neural network 200 shown in FIG. 25, a neural network 200b shown in FIG. 31 further includes an LSTM network 225. The data (the values) that are output from the GNN 220 are input to the LSTM network 225. The data that is output from the LSTM network 225 is input to the fully connected layer 230; and the estimation result of the task from the fully connected layer 230 is output.

Compared to the neural network 200a shown in FIG. 28, a neural network 200c shown in FIG. 32 further includes the LSTM networks 225a to 225c. The data that is output from the GNNs 221 to 223 is input respectively to the LSTM networks 225a to 225c. The data that is output from the LSTM networks 225a to 225c is input to the fully connected layer 230; and the estimation result of the task from the fully connected layer 230 is output.

### LSTM Network

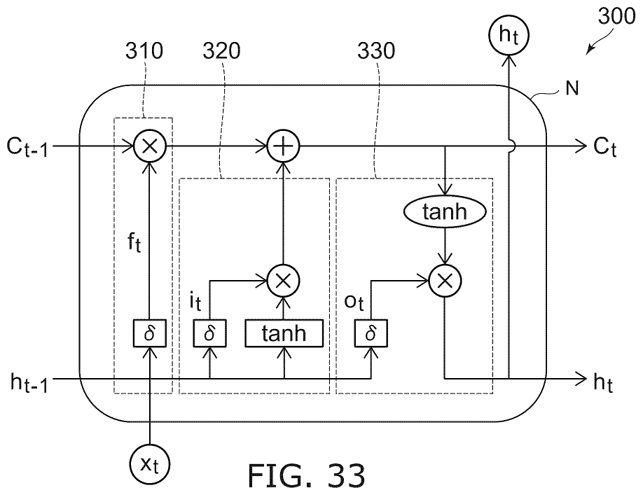

FIG. 33 is a schematic view illustrating the specific structure of the LSTM network.

As shown in FIG. 33, each neuron N of the LSTM network 300 includes a forget gate 310, an input gate 320, and an output gate 330. In FIG. 33, xₜ represents the input value to the neuron N at the time t. Cₜ represents the state of the neuron N at the time t. fₜ represents the output value of the forget gate 310 at the time t. iₜ represents the output value of the input gate at the time t. oₜ represents the output value of the output gate at the time t. hₜ represents the output value of the neuron N at the time t. fₜ, it, Cₜ, oₜ, and hₜ are respectively represented by the following Formulas 2 to 6.

$${f}_{t} = σ ( {W}_{f} \cdot [ {h}_{t - 1} , {x}_{t} ] + {b}_{f} ) \qquad [ Formula 2 ]$$

$${i}_{t} = σ ( {W}_{i} \cdot [ {h}_{t - 1} , {x}_{t} ] + {b}_{i} ) \qquad [ Formula 3 ]$$

$${C}_{t} = {f}_{t} * {C}_{t - 1} + {i}_{t} * tanh ( {W}_{c} \cdot [ {h}_{t - 1} , {x}_{t} ] + {b}_{c} ) \qquad [ Formula 4 ]$$

$${o}_{t} = σ ( {W}_{o} \cdot [ {h}_{t - 1} , {x}_{t} ] + {b}_{o} ) \qquad [ Formula 5 ]$$

$${h}_{t} = {o}_{t} * tanh ( {C}_{t} ) \qquad [ Formula 6 ]$$

### Training

The neural network that is used in the estimation of the task is pretrained. Multiple sets of training data are used in the training. Each set of training data includes input data and teaching data (labels). The input data has a graph structure, and is generated using an image of the actual task. The input data may be prepared using a synthesized image representing the actual task. The method for generating the graph data described above is applicable to generate the input data. The specific structure of the input data to be prepared is modified as appropriate according to the structure of the neural network to be trained. When the neural network 200 shown in FIG. 25 is trained, graph data is used in which the nodes corresponding to the pose, the nodes corresponding to the state of the article, and the nodes corresponding to the work location are selectively connected to each other as shown in FIG. 23 or FIG. 24. When the neural network 200a shown in FIG. 28 is trained, graph data is used in which the nodes corresponding to the pose, the nodes corresponding to the state of the article, and the nodes corresponding to the work location are separated from each other as shown in FIG. 22. The teaching data is labels indicating the task corresponding to the input data. The intermediate layers of the neural network are trained to output teaching data according to the input of the input data.

### Output Example

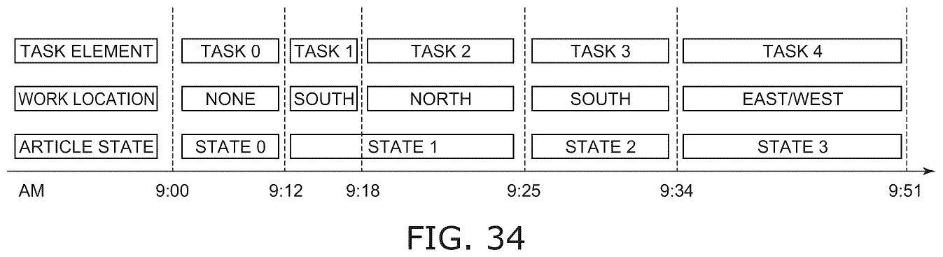

FIG. 34 is a schematic view illustrating an output result of the processing system according to the embodiment.

In FIG. 34, the horizontal direction shows time. The vertical direction shows the estimation results of the article state and work location based on the image at each time. The uppermost row shows the task estimated based on the article state and work location.

While the task is being performed, images of the state of the task are repeatedly acquired. The processing device 20 repeats an estimation of the task based on the images. The task that is being performed by the worker at each time is estimated thereby. For example, the processing system 1 estimates the task in real-time while the task is being performed.

The three sets of information of the pose of the worker, the state of the article, and the work location on the article are used to estimate the task in the examples described above. Embodiments of the invention are not limited to such examples; the pose of the worker and one selected from the state and the work location may be used to estimate the task. When the state (the appearance) of the article changes as the task proceeds, the task can be estimated with high accuracy even without information of the work location. When the work location changes as the task proceeds, the task can be estimated with high accuracy even without information of the state of the article.

Most favorably, the three sets of information of the pose of the worker, the state of the article, and the work location on the article are used to estimate the task. As a result, a wide range of tasks can be estimated with higher accuracy.

Advantages of embodiments will now be described.

Various methods have been tried to estimate the task being performed. Generally, the same movement is repeated in the task; and the change of the movement is small. Therefore, there are many cases where estimating a task is more difficult than estimating a body action such as running, jumping, bending, etc. To estimate a task with high accuracy, there is a method of mounting multiple sensors to the body of the worker. In this method, the task is estimated by determining fine movements of the worker based on the data of the sensors. In such a case, costs are high because many expensive sensors are necessary. Also, it takes time and effort to mount the sensors to the worker; and the sensors may interfere with the task.

For this problem, the processing system 1 according to the embodiment uses at least two sets of information to estimate the task being performed. The at least two sets of information include at least one selected from the pose of the worker, the state of the article, and the work location on the article. This information changes according to the task being performed. Therefore, the task can be estimated by using this information.

According to the embodiment of the invention, the graph data is generated using at least two sets of information to further increase the accuracy of the estimation. The graph data includes multiple nodes and multiple edges. The edges indicate that the nodes are associated with each other. For example, connections between body joints are represented by edges. The processing system 1 obtains the estimation result of the task by inputting the graph data to a GNN.

Some joints of the body are connected to each other by skeletal parts. The movements of such joints are associated with each other. On the other hand, there is little movement association between joints that are not connected by skeletal parts.

For example, the body includes joint combinations having high movement association such as the combination of a wrist and an elbow, the combination of an ankle and a knee, etc. On the other hand, there are joint combinations having low movement association such as the combination of an ankle and a wrist, etc. By using the graph data, the associations between the nodes can be represented. Namely, the set of nodes connected by edges and the set of nodes not connected by edges can be trained independently of each other. When the data used to estimate the task does not have a graph structure, exhaustive training of all nodes is performed assuming that all nodes have associations with each other. By using graph data, more detailed movements can be estimated by considering the associations between the nodes.

The pose of the worker, the state of the article, and the work location can be estimated based on the image. The task can be estimated without mounting sensors to the worker. Accordingly, the task of the worker can be estimated without obstructing the task. The cost necessary to estimate the task also can be reduced.

In particular, complex fine motions arise in a workplace in which articles are manufactured. Also, similar motions may arise even when the tasks are different from each other. Thousands to tens of thousands of parts may be assembled when manufacturing a large made-to-order product (indented product). Therefore, the number of tasks also is extremely high, and it is not easy to estimate the task with high accuracy based on only the pose. By using at least one selected from the state and the work location in addition to the pose, the task can be estimated with high accuracy.

The manufacturing processes of an article include tasks such as assembly tasks, etc., that are greatly dependent on the worker. There are many cases where assembly tasks are complex and diverse. The worker needs adaptability to flexibly adapt to an assembly task. Estimating the task content of the worker while the worker performs the task can be expected to improve the efficiency, standardization, yield, etc., of the task. However, there are a vast number of assembly task types in a manufacturing site. The task content, complexity, task time, etc., greatly change according to the product to be manufactured. Also, there is a wide range of task times for each task, from several minutes to several hours, days, months, etc. It may be necessary to mount more than ten thousand parts to complete one product. When the tasks are estimated for the manufacturing processes of such a product, there are different combinations of information that are effective for the estimation. There may be cases where information that is unnecessary when estimating the assembly task of one product is necessary when estimating the assembly task of another product. Task analysis of the assembly tasks of such products has been performed using various techniques or models. However, such techniques and models are effective for only assembly tasks of specific products. In most cases, application is difficult for assembly tasks of different products. Accordingly, in a conventional estimation method, it is necessary to generate and manage the same number of task analysis techniques or models as the number of product types. When analyzing a new assembly process by a conventional estimation method, it is necessary to generate a technique or model corresponding to the new assembly process from scratch.

The inventors of the application found that by using a GNN to combine multiple sets of information, the task being performed can be estimated with high accuracy for multiple tasks; and the estimation can be performed generically for assembly tasks of various products. For example, the task being performed by a worker can be estimated with high accuracy by preparing an integrated neural network for the estimation for a workplace in which various tasks may be performed. According to embodiments of the invention, the tasks can be estimated more easily and with higher accuracy.

In the processing system 1, auxiliary sensors may be mounted to the body of the worker. For example, an acceleration, angular velocity, etc., of a part of the body may be used in addition to the pose of the worker, the state of the article, and the work location to estimate the task. In such a case as well, the number of necessary sensors can be less than when the task is estimated using only sensors.

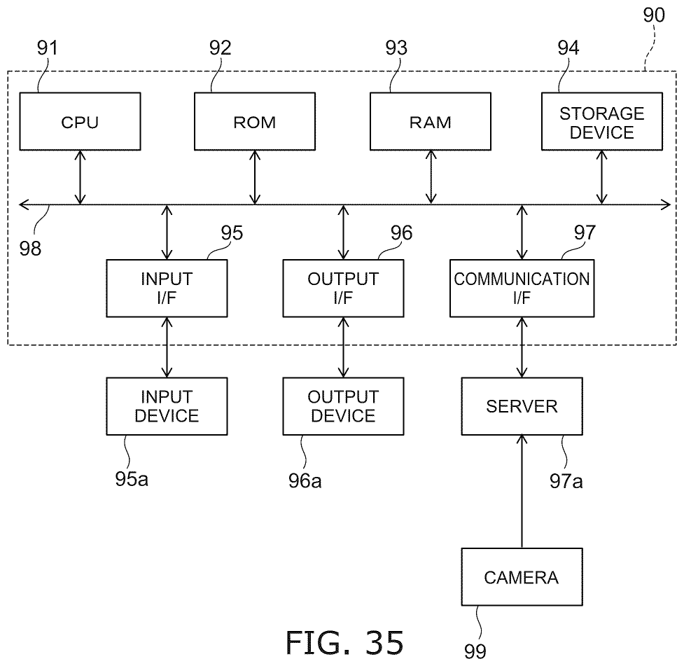

FIG. 35 is a schematic view illustrating a hardware configuration.

For example, the processing device 20 includes the hardware configuration shown in FIG. 35. A computer 90 shown in FIG. 35 includes a CPU 91, ROM 92, RAM 93, a memory device 94, an input interface 95, an output interface 96, and a communication interface 97.

The ROM 92 stores programs that control the operations of the computer. Programs that are necessary for causing the computer to realize the processing described above are stored in the ROM 92. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the memory device 94. When executing the programs, the CPU 91 executes various processing by controlling configurations via a system bus 98.

The memory device 94 stores data necessary for executing the programs and/or data obtained by executing the programs.

The input interface (I/F) 95 connects the computer 90 and an input device 95a. The input I/F 95 is, for example, a serial bus interface such as USB, etc. The CPU 91 can read various data from the input device 95a via the input I/F 95.

The output interface (I/F) 96 connects the computer 90 and an output device 96a. The output I/F 96 is, for example, an image output interface such as Digital Visual Interface (DVI), High-Definition Multimedia Interface (HDMI (registered trademark)), etc. The CPU 91 can transmit data to the output device 96a via the output I/F 96 and cause the output device 96a to display an image.

The communication interface (I/F) 97 connects the computer 90 and a server 97a outside the computer 90. The communication I/F 97 is, for example, a network card such as a LAN card, etc. The CPU 91 can read various data from the server 97a via the communication I/F 97. A camera 99 images an article and stores the image in the server 97a.

The memory device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a speaker, and a printer. A device such as a touch panel that functions as both the input device 95a and the output device 96a may be used.

The memory device 94 can be used as the storage device 30. The camera 99 can be used as the imaging device 10.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

The embodiments may include the following features.

### (Feature 1)

A processing system, configured to:
estimate a pose of a worker based on a first image, the worker and an article being visible in the first image;
estimate at least one selected from a state of the article and a work location of the worker on the article based on the first image;
generate first graph data based on the pose and the at least one selected from the state and the work location, the first graph data including a plurality of nodes and a plurality of edges; and
by inputting the first graph data to a neural network including a graph neural network (GNN) and by using a result output from the neural network, estimate a task being performed by the worker.

### (Feature 2)

The system according to Feature 1, wherein
the state is estimated based on the first image, and
the first graph data includes:
   a plurality of first nodes corresponding respectively to a plurality of joints of the worker;
   a plurality of first edges corresponding respectively to a plurality of skeletal parts of the worker; and
   a plurality of second nodes corresponding respectively to a plurality of the states that the article may be in.

### (Feature 3)

The system according to Feature 2, wherein
in the first graph data, each of the plurality of second nodes is connected with one of the plurality of first nodes by edges.

### (Feature 4)

The system according to Feature 2, wherein
the first graph data includes:
   first data including the plurality of first nodes and the plurality of first edges; and
   second data separated from the first data, the second data including the plurality of second nodes and a plurality of second edges, the plurality of second edges representing associations respectively between the plurality of second nodes, and
   the first data and the second data are input to the neural network.

### (Feature 5)

The system according to Feature 4, wherein
the GNN includes a first GNN and a second GNN,
in the neural network, a fully connected layer receives input of:
   a result output from the first GNN when the first data is input to the first GNN; and
   a result output from the second GNN when the second data is input to the second GNN, and
the task is estimated using a result output from the fully connected layer.

### (Feature 6)

The system according to Feature 1, wherein
the work location is estimated based on the first image, and
the first graph data includes:
   a plurality of first nodes corresponding respectively to a plurality of joints of the worker;
   a plurality of first edges corresponding respectively to a plurality of skeletal parts of the worker; and
   a plurality of third nodes corresponding respectively to a plurality of locations on the article.

### (Feature 7)

The system according to Feature 1, wherein
both of the state and the work location are estimated based on the first image, and
the first graph data includes:
   a plurality of first nodes corresponding respectively to a plurality of joints of the worker;
   a plurality of first edges corresponding respectively to a plurality of skeletal parts of the worker;
   a plurality of second nodes corresponding respectively to a plurality of the states that the article may be in; and
   a plurality of third nodes corresponding respectively to a plurality of locations on the article.

### (Feature 8)

The system according to Feature 1, further configured to:
estimate the pose of the worker based on a second image, the worker and the article being visible in the second image;
estimate at least one selected from the state of the article and the work location of the worker on the article based on the second image;
generate second graph data by using a result estimated based on the second image, the second graph data including a plurality of nodes and a plurality of edges; and
estimate the task by using a result output from the neural network when the second graph data, in addition to the first graph data, is input to the neural network.

### (Feature 9)

The system according to Feature 8, wherein
the plurality of nodes of the first graph data and the plurality of nodes of the second graph data are respectively connected by a plurality of edges, and
the first graph data and the second graph data are input to the neural network.

### (Feature 10)

The system according to Feature 8, wherein
the second image is obtained after the first image,
the second graph data is input to the neural network after the first graph data, and
in the neural network, a long short-term memory (LSTM) network receives input of a result output from the GNN when the first graph data is input to the GNN, and then the LSTM network receives input of a result output from the GNN when the second graph data is input to the GNN.

### (Feature 11)

The system according to Feature 8, wherein
in the neural network, a fully connected layer receives input of:
   a result output from the GNN when the first graph data is input to the GNN; and
   a result output from the GNN when the second graph data is input to the GNN, and
the task is estimated by using a result output from the fully connected layer.

### (Feature 12)

A processing method, comprising:
causing a processing device to
   estimate a pose of a worker based on a first image, the worker and an article being visible in the first image,
   estimate at least one selected from a state of the article and a work location of the worker on the article based on the first image,
   generate first graph data based on the pose and the at least one selected from the state and the work location, the first graph data including a plurality of nodes and a plurality of edges, and
   by inputting the first graph data to a neural network including a graph neural network (GNN) and by using a result output from the neural network, estimate a task being performed by the worker.

### (Feature 13)

A program causing a computer to perform the method according to Feature 12.

### (Feature 14)

A non-transitory computer-readable storage medium storing a program,
the program, when executed by a computer, causing the computer to perform the method according to Feature 12.

According to the embodiments described above, a processing system, a processing method, a program, and a storage medium are provided in which a task can be estimated more easily and with higher accuracy.

In the specification, “or” shows that “at least one” of items listed in the document can be adopted.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions and are within the scope of the inventions described in the claims and their equivalents. The embodiments described above can be implemented in combination with each other.

What is claimed is:

1. A processing system, configured to:
estimate a pose of a worker based on a first image, the worker and an article being visible in the first image;
estimate at least one selected from a state of the article and a work location of the worker on the article based on the first image;
generate first graph data based on the pose and the at least one selected from the state and the work location, the first graph data including a plurality of nodes and a plurality of edges; and
by inputting the first graph data to a neural network including a graph neural network (GNN) and by using a result output from the neural network, estimate a task being performed by the worker.

2. The system according to claim 1, wherein
the state is estimated based on the first image, and
the first graph data includes:
a plurality of first nodes corresponding respectively to a plurality of joints of the worker;
a plurality of first edges corresponding respectively to a plurality of skeletal parts of the worker; and
a plurality of second nodes corresponding respectively to a plurality of the states that the article may be in.

3. The system according to claim 2, wherein
in the first graph data, each of the plurality of second nodes is connected with one of the plurality of first nodes by edges.

4. The system according to claim 2, wherein
the first graph data includes:
first data including the plurality of first nodes and the plurality of first edges; and
second data separated from the first data, the second data including the plurality of second nodes and a plurality of second edges, the plurality of second edges representing associations respectively between the plurality of second nodes, and
the first data and the second data are input to the neural network.

5. The system according to claim 4, wherein
the GNN includes a first GNN and a second GNN,
in the neural network, a fully connected layer receives input of:
a result output from the first GNN when the first data is input to the first GNN; and
a result output from the second GNN when the second data is input to the second GNN, and
the task is estimated using a result output from the fully connected layer.

6. The system according to claim 1, wherein
the work location is estimated based on the first image, and
the first graph data includes:
a plurality of first nodes corresponding respectively to a plurality of joints of the worker;
a plurality of first edges corresponding respectively to a plurality of skeletal parts of the worker; and
a plurality of third nodes corresponding respectively to a plurality of locations on the article.

7. The system according to claim 1, wherein
both of the state and the work location are estimated based on the first image, and
the first graph data includes:
a plurality of first nodes corresponding respectively to a plurality of joints of the worker;
a plurality of first edges corresponding respectively to a plurality of skeletal parts of the worker;
a plurality of second nodes corresponding respectively to a plurality of the states that the article may be in; and
a plurality of third nodes corresponding respectively to a plurality of locations on the article.

8. The system according to claim 1, further configured to:
estimate the pose of the worker based on a second image, the worker and the article being visible in the second image;
estimate at least one selected from the state of the article and the work location of the worker on the article based on the second image;
generate second graph data by using a result estimated based on the second image, the second graph data including a plurality of nodes and a plurality of edges; and
estimate the task by using a result output from the neural network when the second graph data, in addition to the first graph data, is input to the neural network.

9. The system according to claim 8, wherein
the plurality of nodes of the first graph data and the plurality of nodes of the second graph data are respectively connected by a plurality of edges, and
the first graph data and the second graph data are input to the neural network.

10. The system according to claim 8, wherein
the second image is obtained after the first image,
the second graph data is input to the neural network after the first graph data, and
in the neural network, a long short-term memory (LSTM) network receives input of a result output from the GNN when the first graph data is input to the GNN, and then the LSTM network receives input of a result output from the GNN when the second graph data is input to the GNN.

11. The system according to claim 8, wherein
in the neural network, a fully connected layer receives input of:
a result output from the GNN when the first graph data is input to the GNN; and
a result output from the GNN when the second graph data is input to the GNN, and
the task is estimated by using a result output from the fully connected layer.

12. A processing method, comprising:
causing a processing device to
estimate a pose of a worker based on a first image, the worker and an article being visible in the first image,
estimate at least one selected from a state of the article and a work location of the worker on the article based on the first image,
generate first graph data based on the pose and the at least one selected from the state and the work location, the first graph data including a plurality of nodes and a plurality of edges, and
by inputting the first graph data to a neural network including a graph neural network (GNN) and by using a result output from the neural network, estimate a task being performed by the worker.

13. A non-transitory computer-readable storage medium storing a program,
the program, when executed by a computer, causing the computer to perform the method according to claim 12.
